SEQUENCE LISTING (6 sequences)

SEQ ID NO: 1 - DNA, 25 bp, Artificial Sequence
  Description of Artificial Sequence Synthetic probe ON1
aggcgtcgattttaagatgggcgtt

SEQ ID NO: 2 - DNA, 50 bp, Artificial Sequence
  Description of Artificial Sequence Synthetic probe ON2
agcacaatgaagatcaagatcattgctcctcctgagcgcaagtactccgt

SEQ ID NO: 3 - DNA, 50 bp, Artificial Sequence
  Description of Artificial Sequence Synthetic oligonucleotide complementary to the ON2 probe
acggagtacttgcgctcaggaggagcaatgatcttgatcttcattgtgct

SEQ ID NO: 4 - DNA, 25 bp, Artificial Sequence
  Description of Artificial Sequence Synthetic probe ON4
aggcgtcgattttaagatgggcgtt

SEQ ID NO: 5 - DNA, 25 bp, Artificial Sequence
  Description of Artificial Sequence Synthetic probe ON5
aacgcccatcttaaaatcgacgcct

SEQ ID NO: 6 - DNA, 25 bp, Artificial Sequence
  Description of Artificial Sequence Synthetic probe ON6
aggcgtcgattttaagatgggcgtt

(19) United States
(12) Patent Application Publication
(10) Pub. No.: US 2012/0142045 A1
(43) Pub. Date: Jun. 7, 2012

(54) USE OF AN AMORPHOUS SILICON LAYER AND ANALYSIS METHODS

(75) Inventors: Francois Ozanam, Leuville-Sur-Orge (FR); Larbi Touahir, Croix (FR); Elisabeth Galopin, Clamart (FR); Rabah Boukherroub, Villeneuve D'Ascq (FR); Jean-Noel Chazalviel, Bourg-La-Reine (FR); Anne Chantal Gouget, Garches (FR); Sabine Szunerits, Villeneuve D'Ascq (FR)

(73) Assignee: ECOLE POLYTECHNIQUE/DGAR, Palaiseau Cedex (FR)

(21) Appl. No.: 13/376,057

(22) PCT Filed: Jun. 4, 2010
(86) PCT No.: PCT/FR2010/000412

§ 371 Date: Feb. 15, 2012

(30) Foreign Application Priority Data
Jun. 5, 2009 (FR) 0902747

(51) Int. Cl. G01N 21/64; G01N 21/55

(52) U.S. Cl. 435/29; 436/172; 436/164; 436/501

(57) ABSTRACT

A method of detecting substances or reactions of substances in a sample, comprising: (i) providing a layer (CS) based on hydrogenated or unhydrogenated amorphous silicon with attached probes, (ii) bringing the layer (CS) in contact with the sample that may contain the substances that bind specifically to or reacts specifically with the probes, under appropriate conditions for the substances to bind to or react with the probes; (iii) optionally removing non-specifically bound or non-specifically reactive substances; and (iv) detecting the presence or amount of the specifically bound or reactive substances in the sample by surface plasmon resonance (SPR) and/or fluorescence, is described.

### TECHNICAL FIELD

The present invention relates to the use of a continuous layer (CS) based on hydrogenated amorphous silicon in a method of analysis by fluorescence and/or by surface plasmon resonance (SPR).

The present invention can be used in the industrial field, in particular in methods for monitoring biochemical synthesis, for detecting molecules, for detecting an interaction between molecules and for molecular screening.

In the description below, the references between square brackets ([ ]) refer back to the list of references provided after the examples.

### PRIOR ART

The high-throughput measurement of biomolecular interactions, in particular for proteins but also for lower molecular weight molecules such as oligonucleotides, is an important issue in certain fields of application, such as diagnosis or screening in order to search for new medicaments. From this point of view, biosensors offer solutions that are more effective than conventional assays on membranes, especially when they can be used in configurations which allow large-scale parallel measurement of several probe/target pairs on the same support. They also offer a much more effective solution than strategies for detecting, in solution, entities serving as markers for biomolecules, even when effective integrated detection systems are used. For example, Conde et al. (J. Non-Crystal. Solids 2008, 354, 2594-2597) describe a fluorescence detection method using a hydrogenated amorphous silicon (a-Si:H) photodiode with dimensions of 200 μm×200 μm, forming an island on a glass layer. The photodiode is covered with a layer of silicon nitride (SiNₓ), and then with a layer of hydrogenated amorphous silicon carbide (SiC:H) which is 1.96 μm thick. The layer of hydrogenated amorphous silicon carbide is used for the purpose of filtering. This method does not envision the attachment of a probe to the surface of a support. It therefore only makes it possible to detect the presence of a fluorescent label in solution, but it does not make it possible either to envision measurements of biomolecular interactions, or, a fortiori, measurements in parallel and at high throughput.

In order to measure these interactions, it is essential to be able to measure the probe/target pair association/dissociation kinetics as a function of time. The measurement of these interactions in real time is also necessary in order to provide effective solutions for applications in the testing field, in particular when “in-stream” testing is involved, for example for testing products at the chain output, or in monitoring, in particular in environmental detection of toxic markers.

Among the techniques currently available, two types of detection offer effective solutions to the real-time monitoring of molecular interactions: fluorescence and surface plasma resonance (SPR). Readers based on one or other of this type of detection and which enable the real-time and in situ monitoring of the association and/or dissociation of a pair of biomolecules, involving in particular a probe attached to the surface of a solid support, and a target present in a sample to be analyzed, are currently found on the market. Fluorescence offers the best sensitivity, but has the drawback of having to label the targets or the probes with fluorophore groups. Surface plasmon resonance has the advantage of being able to detect interactions between a target and a probe which are unlabeled, but is not as sensitive, in particular if the molecular weight of the molecules detected is not very high. In addition, the coupling of the light and of the active layer requires a precise control of the angle of incidence, and complicates the image detection necessary for high-throughput applications. Localized surface plasmon resonances can be excited in metal layers structured in the form of islands of nanometric sizes. In this case, the constraints linked to the control of the angle of incidence disappear, and the detection is carried out by means of a simple spectroscopic analysis of the optical response of the layer. Unfortunately, in practice, the theoretical sensitivity of the method is not achieved under these conditions, mainly because of limitations in the chemistry of the immobilization of the probes on the nanostructured metal layer.

A method for simultaneously determining biomolecular recognition events by SPR and fluorescence is described in document U.S. Pat. No. 6,194,223, filed on Apr. 13, 1998, and the proprietors of which are Roche Diagnostics GmbH and Boehringer Mannheim GmbH ([1]). In this document, the support comprises a layer of metal, optionally covered with a metal oxide, on a transparent substrate, the probes to be analyzed being immobilized within a self-assembled layer, preferably thiol on gold or silver, or silane on oxide. If it is present, the oxide layer preferably has a thickness of greater than 20 nm. Drawbacks of this technique are a restrictive geometry for SPR excitation, an absence of optimization of the coupling between SPR and fluorescence, and a process for grafting the probes by ionocovalent chemistry which has drawbacks in terms of grafting stability and of residual reactivity of the substrate capable of interfering with the analysis. The drawbacks relating to the grafting process appear to be particularly disadvantageous for real-time measurements, where the analysis protocols generally provide for association/dissociation sequences requiring a support that is sufficiently stable to be reusable.

Methods and an apparatus for simultaneously determining biomolecular recognition events by SPR and fluorescence are described in document WO 2005/040770, filed on Oct. 22, 2004, and the proprietors of which are the University of Arizona and Arizona Board of Regents ([2]). The support described consists of an optical fiber covered with a layer of metal or of semiconductor which is active for plasmon resonance on a transparent substrate, and a detection layer. This detection layer is a polymer synthesized so as to have a molecular imprint of the target to be detected, and to include fluorescent labels, such as rare earth elements. These methods use fluorescent-molecule immobilization means that are not very versatile since it is necessary to synthesize the polymer in the presence of the targets and of the probes, and do not make it possible to establish the best compromise for benefiting from a combined SPR and fluorescence measurement under optimum conditions.

A substrate and a method enabling the simultaneous measurement of luminescence and changes in reflectivity induced by SPR are described in document US 2006066249, filed on Sep. 21, 2005, and the proprietor of which is Wisconsin Alumni Res. Found. ([3]). This substrate consists of a metal layer structured in large islands, greater than 0.1 mm in diameter, deposited on a hydrophobic layer covering a transparent substrate, or directly on the substrate. The role of the hydrophobic sublayer is to extend the scope of the plasmon mode and to thus benefit from a better sensitivity for the detection of the SPR. The changes in reflectivity are measured through the transparent substrate. They can be detected by recording an image. The molecules to be analyzed are immobilized at the surface of the gold islands. The drawbacks of this method are a restrictive geometry for SPR excitation and a process for grafting the probes by boo-covalent chemistry which has disadvantages in terms of grafting stability. This method does not envision the simultaneous detection of fluorescence which, given the choices made for the optimization of the SPR detection, could not be carried out with an optimum sensitivity in the description proposed.

A method and a sensor for detecting fluorescence amplified via a plasmon effect in a geometry which allows fluorescence image acquisition with customary devices, such as a fluorescence microscope or a scanner, are described in document US 2009045351, filed on Jan. 22, 2008, and the proprietor of which is the University of Maryland ([4]). The sensor consists of a metal layer covered with a layer of a periodically structured dielectric. The role of this dielectric layer is to allow coupling of the excitation to the plasmon modes in a geometry that is less restrictive than that described in document U.S. Pat. No. 6,194,223, filed on Apr. 13, 1998, and the proprietors of which are Roche Diagnostics GmbH and Boehringer Mannheim GmbH ([5]). In particular, the excitation no longer has to be in total reflection geometry and becomes possible via the front surface. The sensor comprises variants in which the dielectric layer is itself covered with a second metal layer, and/or the dielectric layer is structured in various regions, each having units of different periodicity, thus allowing optimum enhancement of the fluorescence at a wavelength associated with each unit. The probes to be analyzed are positioned on the dielectric layer, and possibly bound by means of a functionalization of the surface (not described). This method nevertheless has several drawbacks. It still imposes restrictive conditions in terms of controlling the angle of incidence of the excitation, and of positioning and orientation of the sample, all these parameters having to be adjusted according to the region of the support probed in the variants having several units. Moreover, it does not envision the simultaneous detection of SPR, which would prove to be difficult to set up given the constraints existing for the excitation.

A sensor using the amplification of fluorescence via localized plasmon modes of a thin metal layer deposited in the form of islands on a substrate, is described in document U.S. Pat. No. 5,449,918, filed on Aug. 20, 1993, and the proprietor of which is the United Kingdom Government ([6]). The fluorescent probes are located at approximately 6 nm from the surface of the metal islands, and deposited by dipping the sensor in an appropriate solution. However, the architecture proposed for the immobilization proves to be demanding for combining optimization of the analysis and optimum enhancement of the fluorescence. Indeed, the molecular architecture must provide both a means of attaching the fluorescent probes and a spacer of controlled length for optimization of the fluorescence. This results in molecules with a long saturated chain being preferred to act as a spacer and in the use of a deposition technique by dipping which has many drawbacks in terms of immobilization stability and therefore of analysis reliability. Furthermore, the document does not envision the simultaneous detection of localized SPR.

A detection method and an associated support which make it possible to amplify the emission of light from molecules to be analyzed and to acquire a fluorescence image are described in document US 2007273884, filed on Mar. 30, 2005, and the proprietors of which are Omron Tateisi Electronics Co and Wazawa Tetsuichi ([7]). The fluorescence amplification is due to the coupling of the emission to localized surface plasmon modes within the support. Said support consists of a layer of metal particles deposited on a transparent substrate. Molecular probes, which may be a biopolymer, capable of recognizing the molecules to be analyzed—which carry a fluorescent group—are brought into contact with the support and the metal particles. The measurement of the probe-target recognition is carried out upon contact of the solution containing the target molecules to be detected. In this method, the constraints linked to the control of the angle of incidence remain, since the fluorescence excitation is envisioned only in evanescent mode from the rear face of the sensor. Furthermore, no chemical immobilization process is described, and the absence of a functionalization layer in the architecture leads the inventors to prefer a nonspecific solution, such as the depositing of a biopolymer, which results in known limitations, for example in terms of attachment stability (since no coupling is provided for between, on the one hand, the polymer, and, on the other hand, the substrate or the metal layer), or in terms of response time in real-time analyses.

The protection of an active plasmon layer is described in many documents, such as document US 2002085204, filed on Oct. 25, 2001, and the proprietor of which is Texas Instruments Inc. ([8]), which describes the use of hard coatings with a thickness of about from 100 to 300 nm according to the extension of the evanescent plasmon mode, including silicon carbide SIC, diamond-like carbon (DLC) and various oxides or nitrides, deposited by CVD or PECVD. The thickness of the layers envisioned in this case guarantees effective protection of the layer, but prevents enhancement of the fluorescence by SPR being envisioned, in particular when the SPR is localized. Document EP 1 422 315, filed on Nov. 20, 2003, and the proprietor of which is Silverstar SRL ([9]), describes the use of a layer of silicon oxide deposited on a sublayer of titanium in order to protect a metal substrate or film (not explicitly plasmonically active). In this document, the functionalization of the layer is not described, but the nature of the layer means that schemes for grafting probes by iono-covalent chemistry, which has drawbacks in terms of grafting stability and of residual reactivity of the substrate capable of interfering with the analysis, must be envisioned. Document WO 02/052260, filed on Dec. 21, 2001, and the proprietor of which is Hofman Andreas ([10]), describes the use of a physisorbed polymer or of a layer of metal oxide or of silicon oxide onto which can be grafted, via a coupling agent, a host polymer of probe biomolecules for forming a biosensor. Document WO 2007/036544, filed on Sep. 27, 2006, and the proprietor of which is the Centre National de la Recherche Scientifique [National Center for Scientific Research] ([11]), describes a similar structure (with an additional titanium sublayer) in which the probe molecules are directly attached to the protective silicon oxide. In the two documents above, the grafting process used is once again based on an iono-covalent chemistry which has drawbacks in terms of grafting stability and of residual reactivity of the substrate capable of interfering with the analysis. Document U.S. Pat. No. 6,726,881, filed on Aug. 29, 2002, and the proprietor of which is Fuji Photo Film Co. Ltd. ([12]), describes the use of an organosilicon layer, in particular of self-assembled layers of functional silanes, as a protective layer and a layer for attachment of biomolecules, deposited onto the active metal layer of a plasmon resonance sensor. In this case, the organo-mineral hybrid layer imposes, once again (as for an oxide layer), having recourse to a process of functionalization by iono-covalent chemistry which has drawbacks in terms of grafting stability and of residual reactivity of the substrate capable of interfering with the analysis. In summary, these various methods of protection therefore have drawbacks, either in terms of allowing enhancement of the fluorescence, or in terms of carrying out the immobilization of biological molecules or probes in a satisfactory and reproducible manner.

A biosensor based on localized surface plasmon resonance is described in the document A. J. Haes and R. P. Van Duyne (J. Am. Chem. Soc. 2002, 124, 10596-10604 [13]). The sensor consists of silver nanocrystals deposited on a glass surface. The probes to be analyzed are immobilized at the surface of the nanocrystals. The molecular recognition is measured by the shift in the localized surface plasmon excitation absorption band in the absorption spectrum measured in transmission mode. This biosensor does not, however, make it possible to obtain a sensitivity that is as good as that obtained with an analysis by fluorescence.

The document M. E. Stewart et al. (Chem. Rev. 2008, 108, 494-521 [14]) presents a prior art concerning the use of localized surface plasmon resonance (LSPR) for chemical and biological analysis and enhancement of the response in spectroscopic techniques, such as fluorescence. The article by N. Blow (Nature Methods 2009, 6, 389-393 [15]) puts into perspective the contributions of the localized or nonlocalized SPR techniques, and the current developments for studying interactions between proteins. It is emphasized therein that what currently limits the sensitivity of implementations exploiting LSPR for studying interactions between biomolecules is not having sufficiently effective surface chemistry processes for immobilizing biomolecules at the surface of nanoparticles.

The covalent immobilization of molecules and biomolecules on a silicon substrate or porous silicon substrate by reacting surface SiH bonds is described in document US 2004096893, filed on Nov. 18, 2003, and the proprietor of which is the Canada National Research Council ([16]). An application of this method to a particular case of immobilization of a peptide sequence on a thin film of hydrogenated amorphous silicon has been described by C. Dahmen et al. (Thin Solid Films 2003, 427, 201-207 ([17]). However, the application described requires the synthesis of a particular precursor specific to the peptide envisioned. The only examples listed to date regarding the grafting of molecules or biomolecules onto a thin layer of hydrogenated amorphous silicon are limited to the grafting of said peptide sequence ([17]), to the grafting of methyl acrylate ([17]) and to the grafting of nonfunctionalized alkyl chains, described by A. Lehner et al. (J. Appl. Phys. 2003, 94, 2289-2294 [18]). None of these descriptions give a versatile approach which allows the immobilization of a diversified set of molecules or biomolecules on a thin layer of hydrogenated amorphous silicon. There is no known description of immobilization of molecules or biomolecules on a thin film of hydrogenated amorphous silicon-carbon alloy.

Thus, no device nor any method of the prior art offers a satisfactory solution for immobilizing molecules or biomolecules in an analytical device which makes it possible both to obtain the sensitivity of fluorescence and to detect interactions between unlabeled target and probe molecules, while at the same time offering the possibility of detecting the interactions between molecules by means of a simple analysis of the optical response.

There is therefore a real need for tools which overcome these deficiencies, drawbacks and obstacles of the prior art, in particular which confer greater sensitivity of measurement of biomolecular interactions, even for molecules with a relatively low molecular weight, offering in particular the possibility of detecting the interactions by means of a simple and reproducible analysis, allowing high-throughput applications and a possibly real-time measurement, if possible with a reusable substrate.

### DESCRIPTION OF THE INVENTION

The invention makes it possible precisely to overcome the drawbacks of the prior art and to meet these needs.

In particular, the present invention relates to the use of a continuous layer (CS) based on hydrogenated amorphous silicon in a method of analysis by fluorescence and/or by surface plasmon resonance (SPR).

In particular, the present invention relates to the use of a continuous layer (CS) based on hydrogenated or nonhydrogenated amorphous silicon for attaching a probe, in a method of analysis chosen from a method for monitoring biochemical synthesis, a method for detecting molecules, a method for detecting an interaction between molecules and a method of molecular screening, by fluorescence and/or by surface plasmon resonance (SPR).

The invention also relates to a support suitable for implementing the present invention, comprising, in this order:
a substrate (S),
optionally a metal layer (M),
a layer (CS),
optionally a molecular layer (CM) covalently grafted to the layer (CS).

Probes can be deposited on the layer (CS) directly or by means of the molecular layer (CM).

The invention proposes a solution which makes it possible advantageously to combine the advantages of the modes of detection by surface plasmon resonance and by fluorescence. The invention relies in particular on the excitation of localized surface plasmon resonances, so as to allow a simple and combined measurement of the two physical effects.

The inventors have unexpectedly demonstrated that the invention makes it possible to benefit, on the same support, from an increase in sensitivity for fluorescence signals emitted at several wavelengths.

The invention also allows a sensitive and specific double detection both by fluorescence and by SPR.

The solution proposed allows an original approach for going beyond the usual limitation associated with probe immobilization chemistry. In addition, it is compatible with the detection of relatively low molecular weight molecules, such as DNA, but also with that of higher molecular weight molecules, such as proteins.

For the purposes of the present invention, the term “continuous layer” is intended to mean a coating which is in the form of an uninterrupted film. The coating may consist of a layer of material or of several layers of distinct materials. The continuous layer may cover the entire zone, of the substrate, that is used for the analysis. The continuous layer may have, at any point of the coating surface, a thickness of greater than 0.5 nm. Advantageously, this thickness may vary from one point to another of the zone to be analyzed, for example over lateral distances of about from 10 nm to 1 μm, which makes it possible to adjust the surface wetting properties. Advantageously, this thickness can vary over lateral distances of from 1 μm to 1 mm, which makes it possible to spatially modulate the optical properties of the sensor.

For the purpose of the present invention, the expression “based on hydrogenated or nonhydrogenated amorphous silicon” is intended to mean a layer of amorphous material comprising hydrogenated amorphous silicon, in particular from 50 to 100% of amorphous silicon by atomic fraction, and from 0 to 10% of hydrogen by atomic fraction. It is preferably hydrogenated.

For the purpose of the present invention, the term “amorphous” is intended to mean a noncrystalline or partially crystalline form of silicon. The term “partially crystalline” is intended to mean, for example, a layer of silicon consisting of an assembly of crystalline grains of size less than 20 nm, or of such crystalline grains within the noncrystalline matrix. Advantageously, the atoms can be distributed therein in an irregular manner, for example in the form of grains. The atomic structure can thus be disorganized, noncrystalline.

Advantageously, the amorphous material may have an absorption coefficient less than that of crystalline silicon, which allows better enhancement of fluorescence. Advantageously, the transparency of the material is increased in the spectral field used for the excitation and/or the detection during the analysis. Advantageously, it is possible to choose from a wide range of other optical properties, such as the refractive index, by adjusting the composition and/or the microstructure of the amorphous material. Advantageously, it is possible to prepare layers (CS) in the form of monolayers or of multilayers of materials based on hydrogenated or nonhydrogenated amorphous silicon so as to increase the sensitivity and/or the selectivity of the analysis.

The layer (CS) preferably has a thickness which allows the implementation of the invention.

Generally, the thickness of the continuous layer of amorphous material can be chosen so as to benefit from a simultaneous enhancement of the fluorescence and/or plasmon resonance signals, or so as to benefit from a double detection of different fluorophores. It can be determined by any means known to those skilled in the art. Such techniques are, for example, secondary ion mass spectroscopy (SIMS), Rutherford back-scattering spectroscopy (RBS), photoelectron spectroscopy coupled to ion erosion, spectroscopic ellipsometry, optical or infrared transmission spectra analysis, or stripping of the layer on a zone, followed by profilometry measurement at the edge of this zone.

The thickness of the continuous layer of amorphous material can be chosen from the range of values which correspond to the first maximum reflectivity on a graph representing the reflectivity of the analysis structure as a function of the thickness of the continuous layer amorphous material, for the various wavelengths of the radiations used for the excitation and the detection during the analysis. Generally, the thickness of the layer (CS) may be less than 200 nm, advantageously less than 100 nm, than 50 nm or than 20 nm. Advantageously, a layer (CS) with a thickness of less than 20 nm allows better enhancement of the fluorescence by LSPR.

For simultaneous applications by fluorescence and SPR, preferably LSPR, the thickness of the continuous layer based on amorphous silicon may preferably be less than 20 nm. For example, the thickness of the continuous layer based on amorphous silicon may be between 1 nm and 20 nm, or between 5 nm and 15 nm. The thickness of the continuous layer based on amorphous silicon may be equal to 5 nm.

For the purpose of the invention, a layer (CS) may be prepared according to techniques known to those skilled in the art, for example by plasma deposition (PECVD) as described in the document Solomon et al., Phys. Rev. B., 1988, 38, 9895-9901 ([19]) or in the document Tessler and Solomon, 1995, Phys. Rev. B 52, 10962-10971 ([20]), but also by thermal decomposition of silane, or by evaporation, sputtering, laser ablation, or depositions optionally followed by post-hydrogenation (J. I. Pankove, Hydrogenated Amorphous Silicon, Semiconductors and Semimetals Vol. 21, part A: Preparation and Structure, Academic, Orlando, 1984, [21]).

This layer may consist of hydrogenated amorphous silicon, or consist of an alloy of hydrogenated amorphous silicon with a chemical element such as carbon, germanium or nitrogen.

Advantageously, the continuous layer (CS) may be a carbonaceous amorphous silicon alloy. In other words, the layer (CS) may consist of a hydrogenated silicon-carbon alloy. The presence of carbon in the material may make it possible to reduce its optical index and to extend its range of transparency in the visible range on the short wavelength side (toward blue). The effect obtained, which is the basis of the present invention, is fluorescence enhancement.

In this case, the layer (CS) can have an atomic fraction [C]/([C+Si]) of between 0 and 0.4, preferably between 0.1 and 0.2.

For example, the layer (CS) can consist of an a-Si_{0.63}C_{0.37}:H, a-Si_{0.67}C_{0.33}:H, a-Si_{0.80}C_{0.20}:H or a-Si_{0.85}C_{0.15}:H alloy.

The layer (CS) may also be doped by inclusion of impurities, for example with phosphorus or boron atoms. This doping makes it possible to render the layer (CS) conductive, which can be an advantage in the immobilization of the molecules. This doping can advantageously inhibit the fluorescence of the material and thus reduce the background noise during the analyses. The amount of these impurities may be between, for example, 0.001 and 1 at % in the layer (CS). These impurities can be introduced by ion implantation or during a PECVD process in the form of gas added to the reaction mixture. It may, for example, be diborane for boron or phosphine for phosphorus.

Any process known to those skilled in the art which makes it possible to prepare such an alloy can be used. Use may in particular be made of the processes described in the documents Solomon et al. ([19]), Tessler and Solomon ([20]), and Street, R. A., 1991, Cambridge University Press, Cambridge ([22]), but also thermal decomposition of silane, or evaporation, sputtering, laser ablation, or depositions optionally followed by post-hydrogenation ([21]).

For the analysis of the alloy obtained, use may be made of any method for measuring the amount of the various elements in the alloy that is known to those skilled in the art, such as SIMS or photoelectron spectroscopy; the optical properties can be specified by transmission or reflection spectroscopy, spectroscopic ellipsometry or photothermal deflection spectroscopy; the electronic properties can be verified by studying the space-charge-limited current.

The layer (CS) may comprise several continuous layers of amorphous materials, at least one of which comprises hydrogenated amorphous silicon or a hydrogenated amorphous silicon alloy. It may be a stack of layers (CS), i.e. a succession of identical or different layers alternating with one another. This succession of layers may, for example, comprise a stack of layers consisting of hydrogenated amorphous silicon and of layers consisting of a hydrogenated carbonaceous amorphous silicon alloy, or else a stack of layers of hydrogenated silicon-carbon alloys of different compositions. Such a stacking can be repeated about ten times. For example, the layer (CS) may comprise from 2 to 20 layers, preferably from 8 to 12 layers.

Such a stacking of layers (CS) may be carried out by any technique known to those skilled in the art, for instance the techniques cited above: plasma deposition [Solomon et al. ([19]), Tessler and Solomon ([20]), Street, R. A. ([22])], thermal decomposition of silane, evaporation, sputtering, laser ablation, or depositions optionally followed by post-hydrogenation ([21]).

The layer (CS), or the support, has the advantage of being reusable. The supports described in the prior art have the drawbacks of being damaged by the chemical or heat treatments for regenerating their surface, such as washing treatments which call for a change in pH of the medium, for specific solvents, or for a temperature higher than ambient temperature. The inventors have succeeded, after considerable research, in developing the layer (CS) and the support of the invention, which have the advantage of being sufficiently robust to be able to withstand the heat and chemical treatments for regenerating their surface, which makes it possible to reuse them without any loss of sensitivity and thus provides an effective solution for applications in the field of the testing or the monitoring of chemical reactions, or of storage of biological material. Advantageously, the layer (CS) or the support can be reused once the measurements have been carried out.

The support may comprise a substrate (S).

The layer (CS) may be deposited on a substrate (S).

The substrate (S) may consist of any material suitable for supporting the upper layer(s), and which preferably does not interact with the layer (CS).

The substrate (S) may be in the form of a bare solid support or a solid support bearing a layer, a film or a coating. Advantageously, the substrate (S) may be in the form of a flat and continuous surface for better support of the upper layer(s).

The substrate (S) may be transparent or nontransparent.

The substrate (S) may comprise an oxide, a glass, a polymer or a metal, for example a bare glass slide or a glass slide bearing a metal film or a film intended to promote the adhesion of subsequent deposits, or may consist of a composite structure.

The substrate (S) may be covered with a conductive transparent oxide.

The substrate (S) may have a thickness compatible with the implementation of the invention. This thickness may in particular be modified with the function of support of the upper layer(s).

Generally, the thickness of the layers optionally present at the surface of the substrate (S) can be determined by techniques known to those skilled in the art. They may, for example, be SIMS, profilometry, spectroscopic ellipsometry, or transmission or reflection spectrophotometry.

Advantageously, the superficial layers of the substrate (S) may have a thickness of between 0 and 100 nm. It may, for example, be a 5 nm titanium film, with a view to the attachment of a metal film of gold, of silver or of another metal, to be subsequently deposited.

The layer (CS) may be deposited directly on the substrate (S). Any mode of deposition of a silicon-based layer on a substrate (S) known to those skilled in the art can be used. Suitable deposition modes are, for example, the method by PECVD (plasma-enhanced chemical vapor deposition) or those described in the documents Solomon et al. ([19]) and Tessler and Solomon ([20]).

The support may comprise a metal layer (M).

The metal layer (M) may comprise a metal chosen from copper, silver, gold, rhodium, lithium, sodium, potassium, rubidium, cesium, magnesium, calcium, strontium, barium, zinc, cadmium, aluminum, gallium, indium and lead, or a mixture of at least two of these metals. This list includes noble metals and also alkali and alkaline-earth metals, and can be extended to any metal which has good plasmon characteristics, i.e. in LSPR, a full width at half maximum (fwhm) of the plasmon resonance of less than 200 nm.

Any method for preparing the metal layer (M) known to those skilled in the art can be used. It may, for example, be evaporation, sputtering, laser ablation, transfer of particles in solution, or electroless, photochemical or electrolytic deposition, as described in document FR2585730 ([46]) or FR2529582 ([47]).

The metal layer (M) may comprise a stacking of metal layers (M).

When the metal layer (M) is present, the metal layer (M) may be deposited on the substrate (S), and the layer (CS) may be deposited on the metal layer (M).

Advantageously, the stability of the layer (CS) is not affected when it is deposited on the metal layer (M). Advantageously, the presence of the metal layer (M) allows even greater fluorescence enhancement than in the absence of the metal layer (M).

The depositing of the metal layer (M) on a substrate (S) can be carried out by any method known to those skilled in the art. Suitable depositing modes are, for example, Joule-effect or electron-bombardment thermal evaporation, sputtering, laser ablation, or solution deposition, or those described in documents U.S. Pat. No. 6,194,223 ([1]), WO 2005/040770 ([2]), US 2007273884 ([7]), Szunerits et al., J. Phys. Chem. C 2008, 112, 8239-8243 ([35]) or U.S. Pat. No. 5,449,918 ([6]).

The depositing of the layer (CS) on the metal layer (M) can be carried out by any method known to those skilled in the art. Use may be made, for example, of the PECVD method, thermal decomposition of silane, evaporation, sputtering, laser ablation, or the methods described in documents US 2002085204 ([8]), EP 1 422 315 ([9]), WO 2007036544 ([11]) or U.S. Pat. No. 6,726,881 ([12]), replacing the coating layer of these documents with the layer (CS) of the invention.

The layer (CS) can be deposited on only a part of the substrate (S) or of the layer (M), for example according to a geometric configuration appropriate to SPR imaging. In this case, the depositing can be carried out using a mask appropriate to the desired geometric configuration.

The metal layer (M) can have a thickness compatible with the implementation of the invention. This thickness can in particular be modified with the function of support of the upper layer(s).

Generally, the thickness of the metal layer (M) can be determined by techniques known to those skilled in the art. They may, for example, be SIMS or photoelectron spectroscopy coupled to ion erosion, or else optical methods (spectroscopic ellipsometry, transmission or reflection spectro photometry).

The metal layer (M) can have a thickness of between 5 nm and 100 nm. For example, the metal layer (M) can have a thickness of between 5 nm and 50 nm, or a thickness of approximately 35 nm.

The metal layer (M) may be continuous or discontinuous.

For the purpose of the present invention, the term “continuous metal layer” is intended to mean a layer comprising at least one metal distributed homogeneously over the entire surface of the substrate, without inclusion of other material or interruption of the metal surface. For the purpose of the present invention, the term “discontinuous metal layer” is intended to mean a surface comprising at least one metal distributed over a part of the surface, and not over the entire surface. In other words, the surface may comprise interstices in which the metal is not present. In this case, the surface is not homogeneous on the microscopic scale.

When the metal layer (M) is discontinuous, it may comprise aggregates.

These aggregates may be metal crystals organized in a nonpercolating manner, i.e. with an absence of connectivity, for example electrical connectivity, between two distant points of the layer. The organization may be uniform, i.e. an identical amount of metal is present on zones of identical area, when the size of these zones is chosen to be greater than the size of the elementary islands constituting the layer.

These aggregates may have at least two submicronic dimensions, i.e. at least two dimensions less than one micrometer (1 μm), for example between 5 nm and 100 nm. For example, these aggregates may have two submicronic dimensions. Advantageously, these aggregates may have a submicronic thickness and a submicronic width. Alternatively, these aggregates may have three submicronic dimensions.

Advantageously, the layer (CS) makes it possible to protect the metal layer (M).

A layer may be present between the metal layer (M) and the substrate (S). This layer may be, for example, a layer of titanium, of chromium, of germanium, of copper, of palladium or else of nickel. The thickness of this layer may range between 1 nm and 30 nm.

When the substrate (S) comprises or consists of a metal, the metal layer (M) and the substrate (S) may be composed of different metals.

Advantageously, the layer (CS) allows the attachment to its surface of a probe for the analysis. Advantageously, the layer SL allows the immobilization of probes by means of a molecular layer grafted at its surface via covalent bonds, with a grafting quality compatible with analysis both by fluorescence and by SPR.

This probe may be any molecule or biomolecule of which it is desired to study the binding with another molecule or biomolecule present in the medium.

Advantageously, the probe bonded to the layer (CS) may be a ligand, a small organic molecule, a biomolecule, such as a polypeptide or an antibody, a carbohydrate, an oligosaccharide or a DNA or RNA molecule, a microorganism such as a bacterium, or a part of a microorganism.

For the purpose of the present invention, the term “polypeptide” denotes any compound comprising a peptide consisting of a sequence of natural or unnatural amino acids, of L or D form, optionally chosen from proteins, peptides, peptide nucleic acids, lipopeptides or glycopeptides.

For the purpose of the present invention, the term “nucleic acid” is intended to mean a series of modified or unmodified nucleotides for defining a fragment or a region of a nucleic acid, optionally comprising unnatural nucleotides, and which can correspond equally to a double-stranded DNA, a single-stranded DNA and DNA transcription products such as RNAs.

When the molecule to be studied is of polypeptide type, it is possible to search for the presence, in a sample, of a compound of interest capable of specifically recognizing or binding to or adsorbing onto this polypeptide (binding, for example, of antibody-antigen, ligand-receptor, enzyme-substrate type, this list not being limiting). Those skilled in the art will be able to use the standard conditions and protocols well known for specific interactions of this type, as described, for example, in the document Chow et al. ([23]).

The layer (CS) may comprise at its surface a probe or probes of different natures. When the layer (CS) comprises probes of different natures, each probe may be deposited on one part of the layer (CS).

The probe may be totally or partially exposed to the external environment, i.e. it is possible for all or part of these probes not to be included in the layer (CS).

The probe may be directly bonded to the layer (CS). For example, the probe may be adsorbed onto the layer (CS), or bonded by nanoimprint, by lithography, by anchoring or by etching.

Alternatively, the probe may be bonded to the layer (CS) by means of a molecular layer (ML).

In this case, the layer (SL) may comprise at its surface a molecular layer (CM).

This molecular layer (CM) may be covalently grafted to the layer (CS). Any method of covalent attachment which allows the immobilization of probes on silicon, known to those skilled in the art, can be used. It may, for example, be silanization. Preferably, it may be chemical or electrochemical grafting, in particular photochemical or thermal hydrosilylation, as described, for example, in the documents Henry de Villeneuve et al. (C. Henry de Villeneuve, J. Pinson, M. C. Bernard, P. Allongue, J. Phys. Chem. B 101, 2415 (1997) [51]), Fellah et al. (S. Fellah, A. Teyssot, F. Ozanam, J.-N. Chazalviel, J. Vigneron, A. Etcheberry, Langmuir 18, 5851, (2002) [52]), Teyssot et al. (A. Teyssot, A. Fidélis, S. Fellah, F. Ozanam, J.-N. Chazalviel, Electrochim. Acta 47, 2565 (2002) [53]), Gurtner et al. (C. Gurtner, A. W. Wun, M. Sailor, Angew. Chem. Int. Ed. 38, 1966 (1999) [54]), Robins et al. (E. G. Robins, M. P. Stewart, J. M. Buriak, Chem. Commun. 2479 (1999) [55]), in particular photochemical or thermal hydrosilylation, as described, for example, in the documents Szunerits et al. ([35]), WO2008132325 ([29]), Buriak et al. (J. M. Buriak, Chem. Rev. 102, 1271 (2002) [48]), Boukherroub (R. Boukherroub, Curr. Opin. Solid State Mater. Sci. 9, 66 (2005) [49]), Boukherroub et al. (R. boukherroub and S. Szunerits, Electrochemistry at the Nanoscale, Nanostructure Science and technology Series. Eds. P. Schmuki and S. Virtanen, Springer-Verlag New York, LLC, 2008, pp: 183-248 [50]), A. Lehner et al. ([18]).

When the molecule to be studied is of oligosaccharide type, the covalent attachment can be carried out as described in the document by Smet et al., J. Am. Chem. Soc. 2003, 125, 13916-13917 ([44]).

When the molecule to be studied is of antibody type, the covalent attachment can be carried out as described in the document Suo et al., Langmuir 2008, 24, 4161-4167 ([45]).

The implementation of the method of covalent attachment of the layer (CM) on the layer (CS) advantageously makes it possible to put in place a means of attachment on the layer (CS) and/or groups which promote the immobilization of molecules while preserving their activity. Such a means of attachment may be, for example, a succinimide group, a carboxyl group, an amine group, an OH group, an amino acid, an epoxy group, a maleimide group, a thiol group, or a functionalized polymer. An example of a group which promotes the immobilization of molecules while preserving their activity is any molecule of the polyethylene glycol (PEG) family, for example those described in the documents Voicu et al. ([37]), Prime et al. (K. L. Prime et al., J. Am. Chem. Soc., 1993, 115, 10714-10721 [56]), Booking et al. (T. Böbcking et al., Langmuir, 2005, 21, 10522-10529 [57]).

The means of attachment can advantageously allow the formation of a bond with a probe that it is desired to bond to the surface of the layer (CS).

The bond between the means of attachment and the probe may be of covalent or noncovalent nature.

For example, a noncovalent bond may be an ionic bond, a hydrogen bond, a bond involving Van der Waals forces or a hydrophobic bond.

A method for the fabrication of a support suitable for implementing the invention can comprise the following steps:
a) providing a substrate (S);
b) optionally depositing a metal film on said substrate;
c) depositing a continuous layer (CS) based on hydrogenated amorphous silicon on said substrate, or on the metal layer (M) when it is present, by plasma-enhanced chemical vapor deposition (PECVD);
d) optionally hydrogenating the silicon surface;
e) optionally covalently bonding a molecular layer (ML) to the surface of said layer (CS);
f) optionally modifying the molecular layer (CM) by means of one or more steps of physical or chemical treatments with a view to the immobilization of a probe, such as ligands, small organic molecules, biomolecules, micro-organisms or parts of microorganisms, at the surface of said molecular layer.

The probe can be labeled with a fluorescent label so as to carry out a fluorescence analysis method.

For the purpose of the present invention, the term “fluorescence analysis method” is intended to mean an analysis method which exploits the detection of a fluorescent signal.

The fluorescence can be generated by any type of molecule known to those skilled in the art, hereinafter called a “label”, which has the property of absorbing light energy and of rapidly releasing it in the form of fluorescent light.

This label may be a fluorophore or a fluorochrome. It may, for example, be the labels given in table 1.

TABLE 1

| | Absorption | Emission |
|---|---|---|
| Fluorochrome | (nm) | (nm) |
| 1,5-IAEDANS | 336 | 490 |
| 1,8-ANS | 372 | 480 |
| 4-Methylumbelliferone | 385 | 502 |
| 5-Carboxy-2,7-dichlorofluorescein | 504 | 529 |
| 5-Carboxyfluorescein (5-FAM) | 492 | 518 |
| 5-Carboxynaphthofluorescein | 512/598 | 563/668 |
| (pH 10) | | |
| 5-Carboxytetramethylrhodamine (5- | 542 | 568 |
| TAMRA) | | |
| 5-HAT (hydroxytryptamine) | 370-415 | 520-540 |
| 5-ROX (carboxy-X-rhodamine) | 578 | 604 |
| | 567 | 591 |
| 6-Carboxyrhodamine 6G (6-CR 6G) | 518 | 543 |
| 6-JOE | 520 | 548 |
| 7-Amino-4-methylcoumarin | 351 | 430 |
| 7-Aminoactinomycin D (7-AAD) | 546 | 647 |
| 7-Hydroxy-4-methylcoumarin | 360 | 449, 455 |
| 9-Amino-6-chloro-2-methoxyacridine | 412, 43 | 471, 474 |
| (ACMA) | | |
| ABQ | 344 | 445 |
| Acid fuchsin | 540 | 630 |
| Acridine Orange + DNA | 502 | 526 |
| Acridine Orange + RNA | 460 | 650 |
| Acridine Orange, both DNA&RNA | 440-480 | 520-650 |
| Acridine Red | 455-600 | 560-680 |
| Acridine Yellow | 470 | 550 |
| Acriflavin | 436 | 520 |
| Acriflavin Feulgen SITSA | 355-425 | 460 |
| Aequorin (photoprotein) | | 466 |
| AFPs-Autofluorescent proteins- | | |
| (Quantum Biotechnologies) | | |
| Alexa Fluor 350TM | 346 | 442 |
| Alexa Fluor 430TM | 342 | 441 |
| Alexa Fluor 488TM | 431 | 540 |
| Alexa Fluor 532TM | 495, 492 | 519, 52 |
| Alexa Fluor 546TM | 531, 532 | 553, 554 |
| Alexa Fluor 568TM | 556, 557 | 572, 573 |
| Alexa Fluor 594TM | 577, 578 | 603 |
| Alexa Fluor 633TM | 590, 594 | 617, 618 |
| Alexa Fluor 647TM | 632 | 650 |
| Alexa Fluor 660TM | 647 | 666 |
| Alexa Fluor 680TM | 668 | 698 |
| Alizarin complexon | 530-560, | 580 |
| | 580 | 624-645 |
| Alizarin Red | 530-560 | 580 |
| Allophycocyanin (APC) | 630, 645 | 655, 66 |
| AMC, AMCA-S | 345 | 445 |
| AMCA (aminomethylcoumarin) | 345 | 425 |
| | 347 | 444 |
| AMCA-X | 353 | 442 |
| Aminoactinomycin D | 555 | 655 |
| Aminocoumarin | 346 | 442 |
| | 350 | 445 |
| Anilin blue | | 600 |
| Anthrocyl stearate | 360-381 | 446 |
| APC-Cy7 | 625-650 | 755 |
| APTRA-BTC | 466/380 | 520/530 |
| APTS | 424 | 505 |
| Astrazon Brilliant Red 4G | 500 | 585 |
| Astrazon Orange R | 470 | 540 |
| Astrazon Red 6B | 520 | 595 |
| Astrazon Yellow 7 GLL | 450 | 480 |
| Atabrine | 436 | 490 |
| ATTO-TAGTM CBQCA | 465 | 560 |
| ATTO-TAGTM FQ | 486 | 591 |
| Auramine | 460 | 550 |
| Aurophosphine G | 450 | 580 |
| Aurphosphine | 450-490 | 515 |
| BAO 9 (bisaminophenyloxadiazole) | 365 | 395 |
| BCECF (high pH) | 492, 503 | 520, 528 |
| BCEFC (low pH) | 482 | 520 |
| Berberine sulfate | 430 | 550 |
| Beta lactamase | 409 | 447, 52 |
| BFP blue shifted GFP (Y66H) | 381, 382 | 445, 447 |
| Blue Fluorescent protein | 383 | 448 |
| BFP/GFP FRET | | |
| Bimane | 398 | 490 |
| Bisbenzamide | 360 | 461 |
| Bisbenzimide (Hoechst) | 360 | 461 |
| bis-BTC = Ratio Dye, Zn2+ | 455/405 | 529/505 |
| Blancophor FFG | 390 | 470 |
| Blancophor SV | 370 | 435 |
| BOBOTM-1 | 462 | 481 |
| BOBOTM-3 | 570 | 602 |
| Bodipy 492/515 | 490 | 515 |
| Bodipy 493/503 | 533 | 549 |
| Bodipy 500/510 | 509 | 515 |
| Bodipy 505/515 | 502 | 510 |
| Bodipy 530/550 | 528 | 547 |
| Bodipy 542/563 | 543 | 563 |
| Bodipy 558/568 | 558 | 569 |
| Bodipy 564/570 | 564 | 570 |
| Bodipy 576/589 | 579 | 590 |
| Bodipy 581/591 | 584 | 592 |
| Bodipy 630/650-X | 625 | 642 |
| Bodipy 650/665-X | 647 | 665 |
| Bodipy 665/676 | 605 | 676 |
| Bodipy FI | 504, 505 | 511, 513 |
| Bodipy FL ATP | 505 | 514 |
| Bodipy FI-Ceramide | 505 | 511 |
| Bodipy R6G SE | 528 | 547 |
| Bodipy TMR | 542 | 574 |
| Bodipy TMR-X conjugate | 544 | 573 |
| Bodipy TMR-X, SE | 544 | 570 |
| Bodipy TR | 589 | 617 |
| Bodipy TR ATP | 591 | 620 |
| Bodipy TR-X SE | 588 | 616 |
| BO PROTM-1 | 462 | 481 |
| BO-PROTM-3 | 544 | 570 |
| Brilliant Sulfoflavin FF | 430 | 520 |
| BTC-Ratio Dye Ca2+ | 464/401 | 533/529 |
| BTC-5N-Ratio Dye Zn2+ | 459/417 | 517/532 |
| Calcein | 494 | 517 |
| Calcein Blue | 373 | 440 |
| Calcium Crimson TM | 588, 589 | 611, 615 |
| Calcium Green | 501, 506 | 531 |
| Calcium Green-1 Ca2+ Dye | 506 | 531 |
| Calcium Green-2 CA2+ | 506/503 | 536 |
| Calcium Green-5N Ca2+ | 506 | 532 |
| Calcium Green-C18 Ca2+ | 509 | 530 |
| Calcium orange | 549 | 575 |
| | | 576 |
| Calcofluor White | 385, 395, | 437, 440, |
| | 405 | 445 |
| Cascade blue TM | 377 | 420 |
| | 398 | 423 |
| | 399 | |
| Cascade yellow | 399 | 550 |
| | 400 | 552 |
| Catecholamine | 410 | 470 |
| CCF2 (GeneBlazer) | | |
| CFDA | 494 | 520 |
| CFP-Cyan Fluorescent Protein | 430, 433, | 474, 475, |
| | 436, (453) | 476 (501) |
| CFP/YFP FRET | | |
| Chlorophyll | 480 | 650 |
| Chromomycin A | 436-460 | 470 |
| Chromomycin A | 445 | 575 |
| CL-NERF (ratio dye, pH) | 504/514 | 540 |
| CMFDA | 494 | 520 |
| Coelenterazine Ca2+ Dye, | (429) | 465 |
| bioluminescence | | |
| Coelenterazine cp (Ca2+ Dye) | (430) | 442 |
| Coelenterazine f | (437) | 473 |
| Coelenterazine fcp | | 452 |
| Coelenterazine h | (437) | 464 |
| Coelenterazine hcp | (433) | 444 |
| Coelenterazine ip | | 441 |
| Coelenterazine n | (431) | 467 |
| Coelenterazine O | 460 | 575 |
| Coumarin Phalloidin | 387 | 470 |
| C-phycocyanine | | |
| CPM Methylcoumarin | 384 | 469 |
| CTC | 400-450 | 602 |
| CTC Formazan | | |
| Cy2TM | 489 | 506 |
| Cy3.18 | 554 | 568 |
| Cy3.5TM | 581 | 598 |
| Cy3TM | 514 | 566 |
| | 552 | 570 |
| | 554 | |
| Cy5.18 | 649 | 666 |
| Cy5.5TM | 675 | 695 |
| Cy5TM | 649 | 666 |
| | | 670 |
| Cy7TM | 710, 743 | 767, 805 |
| Cyan GFP | 433 (453) | 475 (501) |
| cyclic AMP Fluorosensor (FiCRhR) | 500 | 517 |
| CyQuant Cell Proliferation Assay | 480 | 520 |
| Dabcyl | 453 | |
| Dansyl | 340 | 578 |
| Dansyl Amine | 337 | 517 |
| Dansyl Cadaverine | 335 | 518 |
| Dansyl Chloride | 372 | 518 |
| Dansyl DHPE | 336 | 517 |
| Dansyl fluoride | 356 | none |
| DAPI | 359 | 461 |
| Dapoxyl | 403 | 580 |
| Dapoxyl 2 | 374 | 574 |
| Dapoxyl 3 | 373 | 574 |
| DCFDA | 504, 505 | 529 |
| DCFH (Dichlorodihydrofluorescein | 505 | 535 |
| diacetate) | | |
| DDAO | 463 | 607 |
| DHR (Dihydrorhodamine 123) | 505 | 534 |
| Di-4-ANEPPS | 496 | 705 |
| Di-8-ANEPPS (non-ratio) | 488 | 605 |
| | 498 | 713 |
| DiA (4-Di-16-ASP) | 456 | 591 |
| DiD (Indodicarbocyanine) | 644 | 665 |
| Lipophilic Tracer | | |
| DiD (DilC 18(5)) | 644 | 665 |
| DIDS | 341 | 415 |
| Dil (DilC 18(3)) | 549, 551 | 565 |
| Dinitrophenol | 349 | |
| DiO (DiOC18(3)) | 484, 487 | 501, 502 |
| DiR (Indotricarbocyanine) | 748 | 780 |
| Dir (DilC 18(7)) | 750 | 779 |
| DM-NERF (high pH) | 497/510 | 540 |
| DNP | 349 | |
| Dopamine | 340 | 490-520 |
| DsRed | 558 | 583 |
| DTAF | 494 | 520 |
| DY-630-NHS | 621 | 660 |
| DY-635-NHS | 634 | 664 |
| EBFP | 383 | 447 |
| ECFP | 436 | 474 |
| EGFP | 488, 498 | 507, 516 |
| ELF 97 | 345 | 530 |
| Eosin | 524 | 545 |
| Erythrosin | 529, 532 | 554, 555 |
| Erythrosine ITC | 529 | 555 |
| Ethidium Bromide | 510, 523 | 595, 605 |
| Ethidium homodimer-1 (EthD-1) | 528 | 617 |
| Euchrysin | 430 | 540 |
| EukoLight | | |
| Europium(III) chloride | | |
| EYFP | 513, 520 | 527, 532 |
| Fast Blue | 360 | 440 |
| FDA | 494 | 520 |
| Feulgen (Pararosaniline) | 570 | 625 |
| FIF (Formaldehyd Induced | 405 | 433 |
| Fluorescence) | | |
| FITC (Fluorescein) | 490, 494 | 520, 525 |
| FITC Antibody | 493 | 517 |
| Flazo Orange | 375-530 | 612 |
| Fluo-3 | 480-506, | 520, 527 |
| | 506 | |
| Fluo-4 | 494 | 516 |
| Fluorescein Diacetate | 495 | 520524 |
| Fluoro-Emerald | 361 | 536 |
| Fluoro-Gold (Hydroxystilbamidine) | 555 | 582 |
| Fluor-Ruby FluorX | 494 | 520 |
| FM 1-43TM | 479 | 598 |
| FM 4-46 | 515 | 640 |
| Fura RedTM (high pH) | 572 | 657 |
| Fura RedTM/Fluo-3 | | |
| Fura-2, high calcium | 335 | 505 |
| Fura-2, low calcium | 363 | 512 |
| Fura-2/BCECF | | |
| Genacryl brilliant Red B | 520 | 590 |
| Genacryl Brilliant Yellow 10GF | 430 | 485 |
| Genacryl Pink 3G | 470 | 583 |
| Genacryl Yellow 5GF | 430 | 475 |
| GeneBlazer (CCF2) | | |
| GFP (S65T) | 498 | 516 |
| GFP red shifted (rsGFP) | 498 | 516 |
| GFP wild type, non-UV excitation | 475 | 509 |
| (wtGFP) | | |
| GFPuv | 385 | 508 |
| Gloxalic Acid | 405 | 460 |
| Granular Blue | 355 | 425 |
| Haematoporphyrin | 530-560 | 580 |
| Hoechst 33258 | 345 | 487 |
| Hoechst 33342 | 347 | 483 |
| Hoechst 34580 | 392 | 440 |
| HPTS | 355 | 465 |
| Hydroxycoumarin | 325-360 | 386-455 |
| Hydroxytryptamine | 400 | 530 |
| Indo-1, high calcium | 330 | 401 |
| Indo-1, low calcium | 346 | 475 |
| Intrawhite Cf | 360 | 430 |
| JC-1 | 514 | 529 |
| JO-JO-1 | 530 | 545 |
| JO-PRO-1 | 532 | 544 |
| LaserPro | 795 | 812 |
| Laurodan | 355 | 460 |
| LDS 751 (DNA) | 543 | 712 |
| LDS 751 (RNA) | 590 | 607 |
| Leucophor PAF | 370 | 430 |
| Leucophor SF | 380 | 465 |
| Leucophor WS | 395 | 465 |
| Lissamine Rhodamine | 572, 577 | 591, 592 |
| Lissamine Rhodamine B | 577 | 592 |
| LIVE/DEAD Kit Animal Cells | 494 | 517 |
| Calcein/Ethidium homodimer | 528 | 617 |
| LOLO-1 | 566 | 580 |
| LO-PRO-1 | 568 | 581 |
| Lucifer Yellow | 425, 428 | 528, 536, |
| | | 540 |
| Lyso Tracker Blue | 373 | 422 |
| Lyso Tracker Blue-White | 466 | 536 |
| Lyso Tracker Green | 504, 534 | 511, 551 |
| Lyso Tracker Red | 490 | 516 |
| Lyso Tracker Yellow | 551 | 576 |
| LysoSensor Blue | 374 | 424 |
| LysoSensor Green | 442 | 505 |
| LysoSensor Yellow/Blue | 384 | 540 |
| Mag green | 507 | 531 |
| magdala Red (Phloxin B) | 524 | 600 |
| Mag-Fura Red | 483/427 | 659/631 |
| Mag-Fura-2 | 369/329 | 508 |
| | 369/330 | 511/491 |
| Mag-Fura-5 | 369/330 | 505/500 |
| | 369/332 | 505/482 |
| Mag-Indo-1 | 349/328 | 480/390 |
| | 349/330 | 480/417 |
| Magnesium Green | 506, 507 | 531 |
| Magnesium Orange | 550 | 575 |
| Malachite Green | 628 | |
| Marina Blue | 362 | 459 |
| Maxilon Brilliant Flavin 10 GFF | 450 | 495 |
| Maxilon Brilliant Flavin 8 GFF | 460 | 495 |
| Merocyanin | 555 | 578 |
| Methoxycoumarin | 360 | 410 |
| Mitotracker Green FM | 490 | 516 |
| Mitotracker Orange | 551 | 576 |
| Mitotracker red | 578 | 599 |
| Mitramycin | 450 | 470 |
| Monobromobimane | 398 | 490 |
| Monobromobimane (mBBr-GSH) | 398 | 500 |
| Monochlorobimane | 380 | 461 |
| MPS (Methyl Green Pyronine | 364 | 395 |
| Stilbene) | | |
| NBD | 466 | 539 |
| NBD Amine | 450 | 530 |
| Nile Red | 515-555, | 590, 640 |
| | 559 | |
| Nitrobenzoxadiodole | 465 | 510-650 |
| Noradrenaline | 340 | 490-520 |
| Nuclear Fast Red | 289-530 | 580 |
| Nuclear Yellow | 365 | 495 |
| Nylosan Brilliant lavin E8G | 460 | 510 |
| Oregon Green | 503 | 522 |
| Oregon Green 488-X | 494 | 517 |
| Oregon GreenTM 488 | 490, 493 | 514, 520 |
| Oregon GreenTM 500 | 497 | 517 |
| Oregon GreenTM 514 | 506 | 526 |
| Pacific Blue | 405 | 455 |
| PBFI | 340/380 | 420 |
| PE-Cy5 | 488 | 670 |
| PE-Cy7 | 488 | 755, 767 |
| PerCP | 488 | 675 |
| PerCP-Cy5.5 | 488 | 710 |
| PE-TexasRed [Red 613] | 488 | 613 |
| Phloxin B (Magdala Red) | 524 | 600 |
| Phorwite AR | 360 | 430 |
| Phorwite BKL | 370 | 430 |
| Phorwite Rev | 380 | 430 |
| Phorwite RPA | 375465 | 565 |
| Phosphine 3R | 365 | 610 |
| PhotoResist | 365 | 610 |
| Phycoerythrin B [PE] | 546-565 | 575 |
| Phycoerythrin R [PE] | 565 | 578 |
| PKH26 (Sigma) | 551 | 567 |
| PKH67 | 496 | 520 |
| PMIA | 341 | 376 |
| Pontochrome Blue Black | 535-553 | 605 |
| POPO-1 | 433 | 457 |
| POPO-3 | 533 | 574 |
| PO-PRO-1 | 435 | 455 |
| PO-PRO-3 | 539 | 567 |
| Primuline | 410 | 550 |
| Procicon Yellow | 470 | 600 |
| Propidium Iodide (PI) | (305), | 617 |
| | 536, | |
| | 538 | |
| PyMPO | 412, 415 | 561, 564, |
| | | 570 |
| Pyrene | 360 | 387 |
| Pyronine | 410 | 540 |
| pyronine B | 540-590 | 560-650 |
| Pyrozal Brilliant Flavin 7GF | 365 | 495 |
| QSY 7 | 560 | |
| Quinacrine Mustard | 440 | 510 |
| Resorufin | 488 | 613 |
| Rh 414 | 571 | 584, 585 |
| Rhod-2 | 532 | 716 |
| Rhodamine | 552 | 576 |
| Rhodamine 110 | 496, 497 | 520 |
| Rhodamine 123 | 507 | 529 |
| Rhodamine 5GLD | 470 | 565 |
| Rhodamine 6G | 525 | 555 |
| Rhodamine B | 540 | 625 |
| Rhodamine B 200 | 523-557 | 595 |
| Rhodamine B extra | 550 | 605 |
| Rhodamine BB | 540 | 580 |
| Rhodamine BG | 540 | 572 |
| Rhodamine Green | 502 | 527 |
| Rhodamine Phallicidine | 558, 542 | 575, 565 |
| Rhodamine Phalloidin | 542 | 565 |
| Rhodamine Red | 570 | 590 |
| Rhodamine WT | 555 | 530 |
| Rose Bengal | 525, 540 | 550-600 |
| R-phycocyanine | | |
| R-phycoerythrin (PE) | 565 | 578 |
| S65A | 471 | 504 |
| S65C | 479 | 507 |
| S65L | 484 | 510 |
| S65T | 488 | 511 |
| Sapphire GFP | 395 | 511 |
| SBFI | 340/380 | 420 |
| Serotonin | 365 | 520-540 |
| Sevron Brilliant Red 2B | 520 | 595 |
| Sevron Brilliant Red 4G | 500 | 583 |
| Sevron Brilliant Red B | 530 | 590 |
| Sevron Orange | 440 | 530 |
| Sevron Yellow L | 430 | 490 |
| sgBFPTM | 387 | 450 |
| sgBFPTM (super glow BFP) | 387 | 450 |
| sgGFPTM | 474 | 488 |
| sgGFPTM (super glow GFP) | 474 | 509 |
| SITS | 336 | 436 |
| SITS (Primuline) | 395-425 | 450 |
| SITS (Stilbene Isothiosulfonic | 365 | 460 |
| Acid) | | |
| SNAFL calcein | 506/535 | 535/620 |
| SNAFL-1 | 508/540 | 543/623 |
| SNAFL-2 | 514/543 | 546/630 |
| SNARF calcein | 552/574 | 590/629 |
| SNARF1 | 576/548 | 635/587 |
| Sodium Green | 506, 507 | 532 |
| SpectrumAgua | 433,/53 | 480/55 |
| SpectrumGreen | 497/30, | 538/44, |
| | 590/31 | 524/56 |
| SpectrumOrange | 559/38 | 588/48 |
| | 560 | |
| Spectrum Red | 587, | 612, |
| | 587/35 | 612/51 |
| SPQ (6-methoxy-N-(3- | 344 | 443 |
| sulfopropyl)quinolinium) | | |
| Stilbene | 335 | 440 |
| Sulphorhodamine B can C | 520 | 595 |
| Sulphorhodamine G Extra | 470 | 570 |
| SYTO 11 | 508, 510 | 527, 530 |
| SYTO 12 | 499, 500 | 522, 519 |
| SYTO 13 | 488, 491 | 509, 514 |
| SYTO 14 | 517, 521 | 549, 547 |
| SYTO 15 | 516, 518 | 546, 555 |
| SYTO 16 | 488, 494 | 518, 525 |
| SYTO 17 | 621 | 634 |
| SYTO 18 | 490, 493 | 507, 527 |
| SYTO 20 | 512 | 530 |
| SYTO 21 | 494 | 517 |
| SYTO 22 | 515 | 535 |
| SYTO 23 | 499 | 520 |
| SYTO 24 | 490 | 515 |
| SYTO 25 | 521 | 556 |
| SYTO 40 | 420 | 441 |
| SYTO 41 | 430 | 454 |
| SYTO 42 | 433 | 460 |
| SYTO 43 | 436 | 467 |
| SYTO 44 | 446 | 471 |
| SYTO 45 | 452 | 484 |
| SYTO 59 | 622 | 645 |
| SYTO 60 | 652 | 678 |
| SYTO 61 | 628 | 645 |
| SYTO 62 | 652 | 676 |
| SYTO 63 | 657 | 673 |
| SYTO 64 | 599 | 619 |
| SYTO 80 | 531 | 545 |
| SYTO 81 | 530 | 544 |
| SYTO 82 | 541 | 560 |
| SYTO 83 | 543 | 559 |
| SYTO 84 | 567 | 582 |
| SYTO 85 | 567 | 583 |
| SYTOX Blue | 445 | 470 |
| SYTOX Green | 504 | 523 |
| SYTOX Orange | 547 | 570 |
| Tetracycline | 390-425 | 525-560 |
| Trimethylrhodamine (TRITC) | 555 | 576 |
| Texas RedTM | 595 | 620 |
| Texas Red-XTM conjugate | 595 | 615 |
| Thiadicarbocyanine (DiSC3) | 651, 653 | 674, 675 |
| Thiazine Red R | 596 | 615 |
| Thiazole Orange | 510 | 530 |
| Thioflavin 5 | 430 | 550 |
| Thioflavin S | 430 | 550 |
| Thioflavin TCN | 350 | 460 |
| Thiolyte | 370-385 | 477-488 |
| Thiozole Orange | 453 | 480 |
| Tinopol CBS (Calcofluor White) | 390 | 430 |
| TMR | 550 | 573 |
| TO-PRO-1 | 515 | 531 |
| TO-PRO-3 | 644 | 657 |
| TO-PRO-5 | 747 | 770 |
| TOTO-1 | 514 | 531, 533 |
| TOTO-3 | 642 | 660 |
| TriColor (PE-Cy5) | (488) 650 | 667 |
| TRITC | 550 | 573 |
| TetramethylRodamineIsoThiocyanate | | |
| True Blue | 365 | 425 |
| TruRed | 490 | 695 |
| Ultralite | 656 | 678 |
| Uranine B | 420 | 520 |
| Uvitex SFC | 365 | 435 |
| WW 781 | 605 | 639 |
| X-Rhodamine | 580 | 605 |
| XRITC | 582 | 601 |
| Xylene Orange | 546 | 580 |
| Y66F | 360 | 508 |
| Y66H | 360 | 442 |
| Y66W | 436 | 485 |
| Yellow GFO | 513 | 527 |
| YFP | 513, 520 | 527, 532 |
| YO-PRO-1 | 491 | 506 |
| YO-PRO-3 | 613 | 629 |
| YOYO-1 | 491 | 508, 509 |
| YOYO-3 | 612 | 631 |

The labeling of the probe with the fluorescent label can be carried out by any technique known to those skilled in the art. It may involve, for example, labeling techniques described in the documents Chen et al. Nano Letters, vol. 7, No. 3, 690-696, 2007 ([24]), Bek et al., Nano Letters, Vol. 8, No. 2, 485-490, 2008 ([25]), WO2007036544 ([11]) or Aslan et al., Current Opinion in Chemical Biology, 9:538-544, 2005 ([26]).

The fluorescence can be detected by any apparatus known to those skilled in the art, and in particular those which are commercially available. They may, for example, be fluorescence microscopes, scanners, UV-visible spectrophotometers, such as Ultraspec 2000 (trademark, Pharmacia), Specord 210 (trademark, Analytic Jena), Uvikon 941 (trademark, Kontron Instruments), TRIAD (trademark, Dynex), Varian Cary 50, or in situ fluorescence detection systems such as Hyblive (trademark, Genewave).

For the purpose of the present invention, the expression “method of analysis by surface plasmon resonance” is intended to mean a method which exploits SPR detection. It is also intended to mean the possibility, for the layer (CS), of being denoted as a sensor in surface plasmon resonance studies.

This method can be carried out by means of the support of the invention, in particular a support comprising a metal layer (M).

The method of analysis by SPR can be carried out by means of any apparatus known to those skilled in the art. It may, for example, be the Biacore system, in particular the Biacore 2000 or Biacore 3000 (trademarks) apparatuses, or else the Autolab SPR instrument apparatuses.

This method allows the detection of the interaction of at least two molecules. The surface plasmon is an exponentially decreasing wave on the two sides of the interface separating the metal layer (M) from the biological medium, in parallel to which it propagates. Since the electromagnetic field in the biological medium has the character of an evanescent wave, i.e. the amplitude decreasing exponentially with the distance to the interface, the attachment of molecules to the probes will modify the information contained in the wave, both in terms of its phase and in terms of its amplitude. A variation in the index of the interface during the attachment of target molecules to the surface, where they pair with the probe molecules, is detected.

The method of analysis by SPR can be a method of analysis by localized surface plasmon resonance (LSPR) or standard surface plasmon resonance.

Advantageously, the method of analysis by surface plasmon resonance is a localized surface plasmon resonance method.

In this case, the metal layer (M) is a discontinuous layer.

Surprisingly, the coupling of the LSPR method with an analysis by fluorescence advantageously allows even greater fluorescence enhancement than when the method of analysis of the invention combines an analysis by fluorescence and by standard SPR. The inventors put forward the hypothesis that, in this case, the electro-magnetic field of the light is greatly increased in the interstices of the metal layer, which allows better fluorescence enhancement than when standard SPR is implemented. It should also be noted that LSPR can be excited independently of the angle of incidence, in reflection or transmission geometries, therefore in a particularly simple manner, suitable for high-throughput analyses, and compatible with a geometry that is convenient for the detection of fluorescence.

Up until now, it was complicated to carry out quantitative and qualitative analyses of the progression of these molecular recognition reactions. The present invention makes it possible, via a simple, inexpensive and rapid means, to monitor these progressions with a much better sensitivity.

Advantageously, the detection by fluorescence and the detection by localized surface plasmon resonance can be carried out consecutively or simultaneously.

Advantageously, the invention can be implemented in the context of a real-time detection and under the usual test conditions in a physiological medium.

Advantageously, the invention can also allow in situ analyses, i.e. real-time analyses. The increased sensitivity of the system can make it possible to take measurements with a very short acquisition time while at the same time retaining a moderate power of the excitation laser, and also to carry out more precise quantitative and qualitative analyses than with a method of analysis by fluorescence and standard SPR. A measuring apparatus which allows in situ measurements in a liquid medium by reflection can be employed by means of the apparatus described by P. Neuzil and J. Reboud (Anal. Chem. 2008, 80, 6100-6103 [27]).

The invention can be implemented in a liquid medium. Systems for reading an image of fluorescence emitted in situ in a liquid medium are well known to those skilled in the art, for example the one described in document WO2008132325 ([28]).

Surprisingly, the invention can allow detection via simultaneous or nonsimultaneous ein-point measurements.

Advantageously, the signals can be acquired in reflection or transmission mode.

The signals can also advantageously be acquired in the form of an image for parallel analysis of various probes immobilized on the support or on the layer (CS).

The present invention can be used, for example, in a method for monitoring the progression of a biochemical synthesis, a method for detecting an interaction between ligands, small organic molecules or biomolecules, a method for detecting an interaction between a biomolecule and a microorganism or part of a microorganism, a method of molecular screening or for the detection of a substance in a sample, or a method for monitoring reactions, binding or adsorption between a substance present in a sample and a probe bonded to the support.

Those skilled in the art will be able to use the standard conditions and protocols known for methods of this type that it is desired to implement. For example, those skilled in the art will be able to use the conditions and protocols described in the documents Chen et al. ([24]), Bek et al. ([25]), WO2007036544 ([11]), Aslan et al. ([26]), or Ciampi et al., 2007 Langmuir 23, 9320-9329 ([30]), by replacing the supports with the support described in the present invention.

A method for detecting a substance in a sample or for monitoring a reaction, binding or adsorption between a substance present in a sample and a compound bonded to the support or to the molecular layer (CM) can comprise the following steps:
i) preparing a support or a layer (CS) on which a compound is immobilized,
ii) bringing the support or the layer (CS) into contact with a sample that may contain a substance which binds specifically to the compound, under appropriate conditions for the binding or the adsorption of the substance to the compound,
iii) optionally carrying out a washing step in order to remove the substances bound or adsorbed nonspecifically,
iv) determining the presence or the amount of substance in the sample by SPR and/or by fluorescence.

Another subject of the invention relates to a kit for diagnosis or for analysis of a substance in a sample, comprising a layer (CS) or a support as defined above and means of detection by surface plasmon resonance (SPR) and/or by fluorescence as defined above.

Another subject of the invention relates to an analytical device comprising a layer (CS) or a support as defined above.

Other advantages may become further apparent to those skilled in the art upon reading the examples below, illustrated by the appended figures, given by way of illustration.

### BRIEF DESCRIPTION OF THE FIGURES

FIG. 1(a) represents a schematic view of the architecture of a DNA chip comprising a layer a-Si₁₋ₓCₓ:H deposited on an aluminum reflector. FIG. 1(b) represents a schematic view of the architecture of a DNA chip without reflector which makes it possible to use Si—C attachment chemistry with the conventional properties of a glass substrate. FIG. 1(c) represents the theoretical fluorescence F (solid line, left-hand scale) compared with the measurement of fluorescence intensity (symbols, right-hand scale) as a function of the thickness of the layer a-Si_{0.85}C_{0.5}:H expressed in nanometers. The calculation is carried out for the Cy5 label (excitation at 635 nm, emission at 670 nm). In order to obtain an appropriate rendering, the two scales were adjusted by translation. The dashed curve represents the theoretical fluorescence F calculated for a layer of a-Si_{0.85}C_{0.15}:H deposited directly on glass [scheme (b)]. The dotted horizontal line is the value of F calculated for a very thick layer of a-Si_{0.85}C_{0.15}:H.

FIG. 2 represents diagrams of the fluorescence intensity and the shapes of the spots obtained on commercial slides (a, d), on a-Si_{0.85}C_{0.15} (112 nm)/glass (b, e) and on a-Si_{0.85}C_{0.15} (44 nm)/Al/glass (c, f), after spotting (a, b, c) and after hybridization (d, e, f). The spots of the 25 nucleotides of ON1 labeled directly with Cy5 are shown at the top, and the spots after hybridization between unlabeled 50-nucleotide strands hybridized with their complementary oligonucleotides labeled with Cy5 are shown at the bottom. The values of the histograms correspond to the median values corrected with the (low) background noise fluorescence values, measured in the vicinity of the spots.

FIG. 3A represents the fluorescence intensity after 30 minutes of hybridization, as a function of the number of hybridization/dehybridization cycles, standardized with respect to the first cycle. FIG. 3B shows a hybridization/dehybridization cycle measured in situ with a Hyblive machine (trademark): (A) introduction of the solution containing the complementary targets labeled with Cy5, (B) post-hybridization washing cycles, (C) introduction of the dehybridization solution; (D) rinsing after dehybridization.

FIG. 4 represents (A) a scheme of the LSPR interface, composed of a multilayer structure, where the gold nanostructures have been coated with a thin film of a-Si₁₋ₓCₓ:H, (B) the scanning electron microscopy (SEM) image typical of the LSPR interface formed. A nanoparticle size distribution histogram is represented in (C).

FIG. 5 represents the UV-visible (UV-Vis) transmission spectrum in air of an interface of glass/nanoparticles of gold coated with a 20 nm-thick film of a-Si₁₋ₓCₓ:H, x ranging from 0.03 to 0.37 as indicated in the figure.

FIG. 6 represents (A) the UV-Vis transmission spectrum in air of an interface of glass/nanoparticles of gold covered with superposed layers of a-Si_{0.8}C_{0.2}:H of increasing thickness; (B) the variation in the shift in the LSPR maximum as a function of the thickness in nm of the superposed layer of a-Si_{0.8}C_{0.2}:H.

FIG. 7 represents (A) the reaction scheme for a surface a-Si_{0.8}C_{0.2}:H that is hydrogenated with undecylenic acid and the subsequent functionalization; (B) the ATR-FTIR spectrum of a film of a-Si_{0.8}C_{0.2}:H that is 20 nm thick, recorded with polarizations p and s; (C) the ATR-FTIR spectrum of the same film of a-Si_{0.8}C_{0.2}:H modified with undecylenic acid; the dotted lines correspond to the curves adjusted for calculating the superficial concentrations of carboxyl groups bonded to the surface.

FIG. 8 represents the ATR-FTIR spectrum of a-Si_{0.8}C_{0.2}:H modified with undecylenic acid (a), reaction with EDC/NHS (b), and amidation with ethanolamine (c); the gray lines correspond to the curves adjusted for calculating the superficial concentrations of functional groups bonded to the surface.

FIG. 9 represents a diagram of fluorescence intensity on a commercial slide and a slide of a-Si_{0.8}C_{0.2}:H (5 nm) on gold nanoparticles. These values obtained after immobilization of the ON4 probes correspond to the median values corrected with the (low) background noise fluorescence values, measured in the vicinity of the spots.

FIG. 10 represents a hybridization/dehybridization/hybridization cycle measured in situ by fluorescence: (A) introduction of the solution containing the complementary targets labeled with Cy5, (B) post-hybridization washing cycles, (C) introduction of the dehybridization solution; (D) rinsing after dehybridization.

FIG. 11 represents the change in absorption (LSPR signal) at 536 nm during the hybridization measured in situ by optical spectrometry. The hybridization corresponds to the probe/target recognition of the ON5 probe oligos and the ON6 target oligomers.

FIG. 12 represents (A) the scheme of the surface plasmon resonance interface, composed of a multilayer structure in which a thin film of gold was coated with a fine film of a-Si₁₋ₓCₓ:H, (B) the surface hydrogenation of a fine film of a-Si₁₋ₓCₓ:H and the subsequent functionalization with undecylenic acid.

FIG. 13 represents the curves of reflectivity as a function of angle of incidence (expressed in degrees) of reflectivity of the SPR substrates coated with thick films of a-Si₁₋ₓCₓ:H 10 nm (A) and 5 nm (B): or which are not coated (thin curve in black), a—Si_{0.80}C_{0.20} (gray points), a—Si_{0.67}C_{0.33} (light gray points), a-Si_{0.63}C_{0.37} (thick curve in black) in water; the experimental values obtained (circles) were compared with the theoretical curves for SPR (curves) calculated using WinSpall 2.0., (C) list of the refractive indices at 630 nm determined from SPR measurements and optical measurements of reflectivity (Solomon et al., Phys. Rev. B., 1988, 38, 13263-13270 [34]).

FIG. 14 represents (A) the measurements of resistance (expressed in μΩ.cm) of the analytical supports as a function of the thickness of the layer (SL) (expressed in nm) and (B) the curves of cyclic voltammetry in an aqueous solution of Fe(CN)₆⁴⁻ (10 mM)/PBS (0.1M) for a 50 nm gold film deposited on glass with a 5 nm titanium adhesion sublayer which is uncoated (black line) and coated with 5 nm of a-Si_{0.63}C_{0.37} (light gray), a-Si_{0.67}C_{0.33} (gray) and a-Si_{0.80}C_{0.20} (dotted black), sweep speed: 0.05 Vs⁻¹, A=0.07 cm².

FIG. 15 represents the XPS analysis spectrum of a-Si_{0.63}C_{0.37} before (a) and after reaction with undecylenic acid (b).

FIG. 16 represents the C1s high-resolution XPS spectrum of a-Si_{0.63}C_{0.37} as deposited before (a) and after reaction with undecylenic acid (b).

FIG. 17 represents schematically the process of grafting biotin comprising an NH₂ ending onto the surface comprising an acid ending by means of a treatment via NHS/EDC.

FIG. 18 represents (A) the curves of reflectivity as a function of the angle of incidence of gold substrates (black) coated with 5 nm of a-Si_{0.63}C_{0.37} comprising an acid ending (gray) and modified with biotin (light gray) in PBS. Values obtained experimentally (dotted curves) compared with the theoretical SPR curves (solid-line curves) calculated by means of WinSpall 2.0, (B) SPR curves associated with the interaction of avidin (10 μg/ml) with a biotin-modified Au/a-Si_{0.63}C_{0.37} surface (black), and with an unmodified Au/a-Si_{0.63}C_{0.37} surface (gray).

### EXAMPLES

### Example 1

### Preparation of Highly Sensitive, Reusable Fluorescence Biosensors Based on Hydrogenated Amorphous Silicon-Carbon Alloys

### 1) Sample Preparation

A thin film of a-Si₁₋ₓCₓ:H is deposited on substrates by low-power PECVD (for x=0.15, gas flow rate: 9 sccm (SiH₄), 24 sccm (CH₄), plasma: 13.56 MHz and 100 mWcm⁻², substrate temperature: 250° C., rate of deposition: 1.2 μmh⁻¹ (Solomon et al., [19]). The substrates used are nonfunctionalized glass microscope slides on which a layer of aluminum approximately 200 nm thick may (or may not) be deposited by evaporation under vacuum.

The a-Si₁₋ₓCₓ:H surface is hydrogenated by exposure to HF (hydrogen fluoride) vapors for 15 seconds, and then grafted with 10-carboxydecyl chains via an undecylenic acid photochemical hydrosilylation (312 nm, 6 mWcm⁻², for 3 h), and finally rinsed with acetic acid (75° C., 30 min) (Faucheux et al., 2006 Langmuir 22, 153-162 [31]). The grafting is validated by attenuated total reflectance infrared spectroscopy, by depositing fine layers of hydrogenated amorphous silicon-carbon alloy on a crystalline silicon substrate. The surface concentration of the grafted carboxydecyl chains is approximately 10¹⁴ chains cm⁻². The carboxyl groups are then activated in a mixture of N-ethyl-N′-dimethyl-aminopropylcarbodiimide and N-hydroxysuccinimide (5 mM/5 mM) at 15° C. for 1 h30.

### 2) Immobilization and Hybridization Protocols

Two oligonucleotide probes are used: a 25-mer probe [5′—NH₂—(CH₂)₆-AGG-CGT-CGA-TTT-TAA-GAT-GGG-CGT-T-Cy5 3′] (SEQ ID NO. 1) called ON1 and an unlabeled 50-mer probe [5′ AGC-ACA-ATG-AAG-ATC-AAG-ATC-ATT-GCT-CCT-CCT-GAG-CGC-AAG-TAC-TCC-GT-(CH₂)₆—NH₂ 3′] (SEQ ID NO. 2) called ON2. The two probes, diluted to 10⁻⁵M in 150 mM of a phosphate buffer containing 0.01% of SDS (sodium dodecyl sulfate) at pH 8.5, are deposited by contact on the activated surface using a Biorobotics MicroGrid II depositing robot. A commercial glass slide functionalized with succinimidyl ester groups serves as a reference. After depositing, the nonamidated succinimidyl ester sites are blocked with ethanolamine (5×10⁻²M, for 15 min), and then the slides are rinsed in 0.1% SDS (pH 6.5) then in ultrapure water (Millipore), and dried under a nitrogen stream. The surface is then exposed to a solution with a concentration of 5×10⁻⁹ M containing the Cy5-labeled oligonucleotide complementary to the ON2 probe (5′ AC-GGA-GTA-CTT-GCG-CTC-AGG-AGG-AGC-AAT-GAT-CTT-GAT-CTT-CAT-TGT-GCT-Cy5 3′) (SEQ ID NO. 3) at 42° C. for 1 hour in Hyb2× buffer sold by Genewave. Post-hybridization rinses for 2 minutes are then carried out, using 3 buffers sold by Genewave (wash1 10×, wash2 10× and wash3 10×, all diluted to 1×).

### 3) Measurements of Fluorescence

The ex situ measurements are carried out at each step of the protocol described above with a fluorescence scanner (Axon Instruments Personal 4100A). Several hybridization/dehybridization cycles are carried out in situ (Marcy et al., 2008, BioTechniques 44, 913-920 [32]), by means of a Hyblive (trademark, Genewave) real-time hybridization station. The dehybridization is carried out in situ at 50° C. in the same chamber in a mixture of formamide and 2.5×SSC (saline sodium citrate buffer) (50:50 by vol.). A fluorescence image (integration time 1 second) was taken every 30 seconds.

### 4) Results

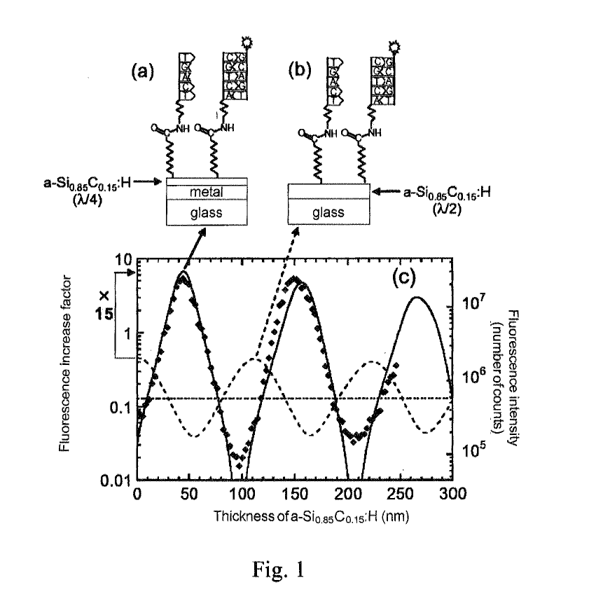

FIG. 1 a-b shows the two structures taken into consideration. FIG. 1a represents a structure comprising a layer a-Si_{0.85}C_{0.15}:H deposited on a layer of metal. The layer of metal itself being deposited on glass. FIG. 1b represents a layer a-Si_{0.85}C_{0.15}:H deposited directly on glass. FIG. 1c shows the theoretical factor F(d) which affects the fluorescence intensity (curves in solid and dotted lines) as a function of the thickness d of a-Si_{0.85}C_{0.15}:H. F(d) is calculated from the conventional optical equations (Born and Wolf, 1970. Principles of Optics, fourth ed. Pitman Press, Bath [33]), for a normal incidence excitation and an emission collected on a cone of half-aperture of 45°. The possible increase in the quantum yield due to optical coupling between the fluorophores and the reflector is ignored. The emission is assumed to be nonpolarized. The oscillation behavior is quite obviously an effect due to interference between the ray reflected directly at the surface and a ray having gone through the layer a-Si_{0.85}C_{0.15}:H and being reflected at the reflector/layer or glass/layer interface. The constructive interferences occur when the difference in optical path between these two rays is an integer multiple of the wavelength. However, this precise condition cannot be met simultaneously for the excitation (wavelength 635 nm) and for the emission (wavelength 670 nm). The real factor F(d), which affects the fluorescence intensity, is the product of two periodic functions f_{exc}(d) (excitation factor) and f_{coll}(d) (collection factor) with slightly different periods. The net result is the low damping of the oscillations that can be seen in FIG. 1c. Furthermore, since the emission is collected on a half-aperture angle of 45° and the difference in optical path depends on the angle of incidence, the oscillation period for the collection factor f_{coll}(d) is in reality distributed, which brings about an additional contribution to the damping (the absorption of the material also contributes to this damping, but to a much lesser extent).

In the absence of a reflector, the curve calculated (FIG. 1c, dashed line) predicts a first maximum at 112 nm without any increase in fluorescence. Indeed, a direct deposit of λ/2 of the layer a-Si_{0.85}C_{0.15}:H on glass is optically equivalent to the “bare” glass, and the only difference with ordinary slides is the difference in grafting chemistry. Subsequently, when structures without a rear reflector are considered, a thickness of 112 nm will be chosen.

In the presence of a reflector, the curve calculated (FIG. 1c, continuous line) shows that the factor F is equal to 7 for an optical thickness of 44 nm (the thickness of the “λ/4 layer” is not exactly half that of the “λ/2 layer”, because the phase change associated with the reflection from the metal differs from its ideal value of π). For high thicknesses, the factor F calculated decreases to 0.12 because of the high refractive index of the solid a-Si_{0.85}C_{0.15}:H. In the ideal case where the fluorophores are free in the air, F is equal to 1 by definition. As it happens, in a conventional architecture where the fluorophores are deposited on glass, the factor F is 0.45. Thus, an improvement by a factor of approximately 15 relative to a standard slide is obtained. In order to test these theoretical predictions, a layer is deposited using a movable cover during the PECVD step in order to continuously vary the thickness d of the layer on the same substrate. The fluorescence intensity measured on the spots is shown in FIG. 1c (diamonds), with the scales being adjusted. There is therefore a good balance between the theory and the experiment. In what follows, the optimized structure consists of a layer of a-Si_{0.85}C_{0.15}:H which is 44 nm thick, deposited on an aluminum reflector.

4.1) Comparison of the Optimized Slides with the Commercial Slides

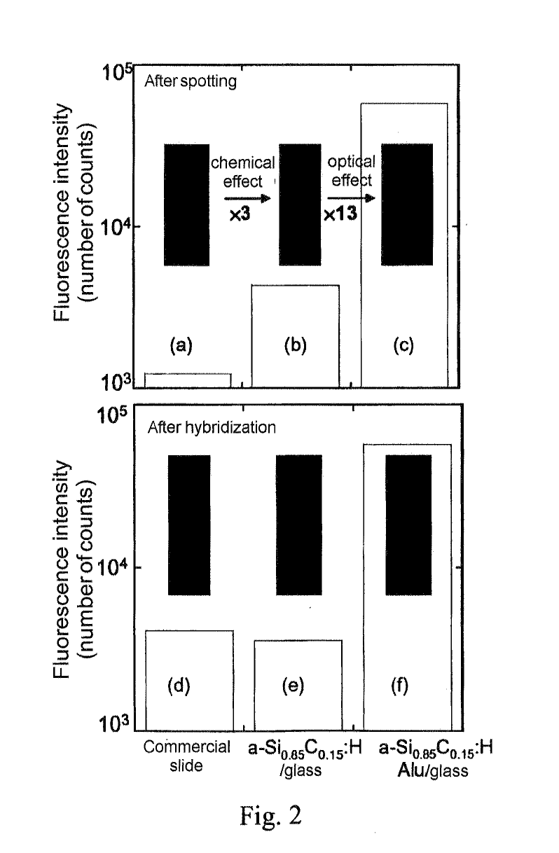

FIG. 2 compares the fluorescence intensity measured on the two structures defined above (a glass slide bearing a layer of a-Si_{0.85}C_{0.15}:H which is 112 nm thick (“λ/2 layer”) (FIG. 2b,e) and a layer of a-Si_{0.85}C_{0.15}:H which is 44 nm thick, on a reflector (FIG. 2c,f)) with those measured on a commercial slide (a, d), after immobilization of the Cy5-labeled ON1 probe (FIG. 2 a,b,c) and hybridization of the ON2 probe with the Cy5-labeled oligonucleotide complementary thereto (FIG. 2 d,e,f). In order to be able to compare them, the same conditions were used on our slides and on the commercial glass slides.

The increase in fluorescence intensity from (b) to (c) can be attributed to the optimized optics (“physical” effect). Since a λ/2 layer is optically equivalent to “bare” glass, the increase in sensitivity from (a) to (b) in FIG. 2 can be attributed to the improvement in the surface chemistry (“chemical” effect). FIG. 2 shows that the total improvement is about a factor of 40, with a factor of 13 attributed to the optics and a factor of 3 attributed to the surface chemistry. Several points should be noted: i) the slides based on Si—C chemistry (FIG. 2(b) and (c)) show essentially no loss of fluorescent signal after washing, which is evidence of the stability of the covalent immobilization of the probes; ii) the spots (b) and (c) are clearly circular and reproducible; iii) despite the strong increase in the signal, the level of the background noise in (c) remains low, which indicates a weak fluorescence of the substrates. FIG. 2 (d-f) shows the result of a similar comparison in terms of hybridization (unlabeled probe oligomers hybridized with the Cy5-labeled targets). While the commercial slide (d) shows an improvement in the fluorescence, the results of (e) and (f) are essentially equivalent to those obtained with the spotting. Once again, the background noise of the slide (f) is very low, indicating a very low nonspecific adsorption of targets. The aging of the slides is tested by storing them in a solution of 1×SSC (pH˜7) for one month. No measurable degradation of the fluorescence was observed.

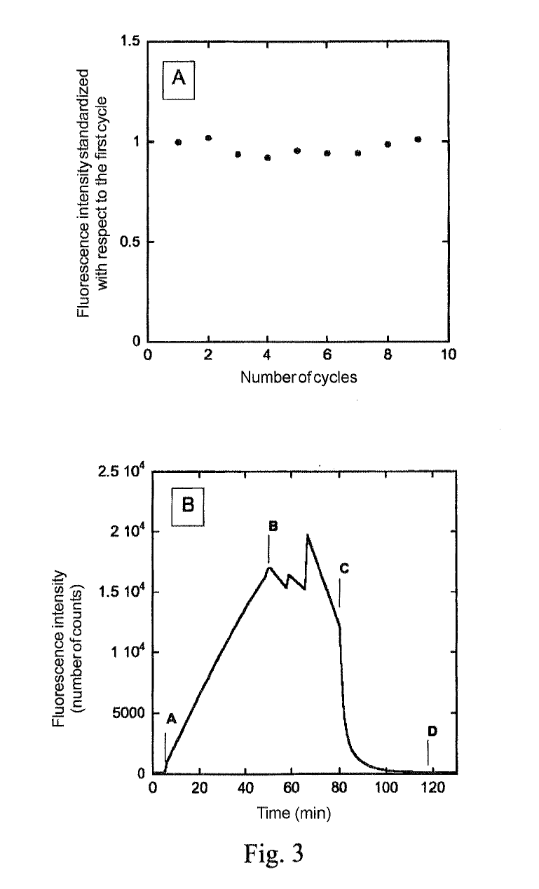

FIGS. 3A and 3B show that this support makes it possible to record several successive hybridization-dehybridization cycles without loss of sensitivity.

### Example 2

### Carbonaceous Amorphous Silicon Alloys as Thin Coating Films of Gold Nanostructures for a Double Detection: Localized Surface Plasmon Resonance and Fluorescence

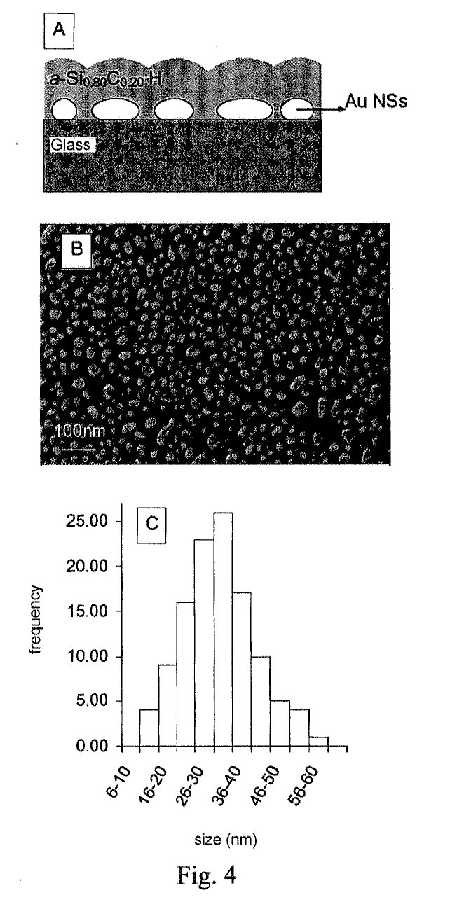

Gold nanostructures (NSs) are prepared on a glass substrate by thermal evaporation of a 4 nm thin gold film, followed by demolding of the film by means of a rapid heat treatment: annealing at 500° C. for 60 seconds under N₂ (Szunerits et al., J. Phys. Chem. C 2008, 112, 8239-8243 [35]). FIG. 4B shows an SEM (scanning electron microscopy) image of the surface which results therefrom. The mean size of the gold nanostructures is approximately 33 nm (FIG. 4C). These interfaces exhibit strong extinction bands in the UV-visible transmission spectrum due to the excitation of the localized surface plasmons (LSPR) on the gold nanostructures described. The nanostructures exhibit a maximum absorption at λₘₐₓ=575 nm, an absorption of 0.24 and a full width at half maximum (fwhm) of 120 nm.

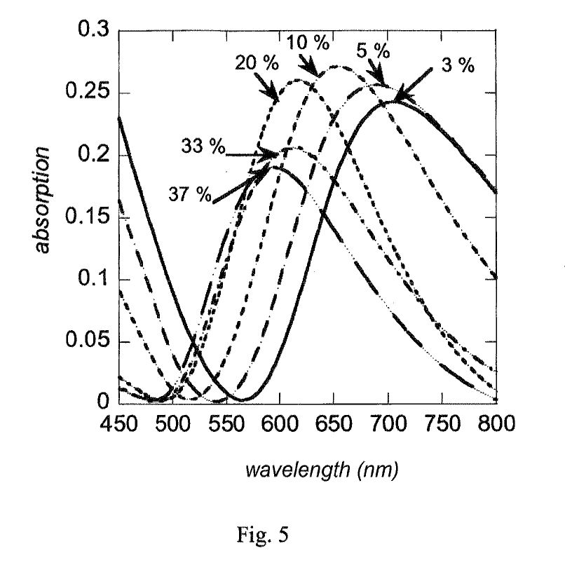

Thin films of amorphous silicon-carbon alloy (a-Si₁₋ₓCₓ:H) are subsequently deposited in a controlled manner by a “low-power” PECVD as described by Solomon et al. ([19]) on the surfaces exhibiting the nanostructures. The variation in the amount of methane in the gas mixture ([CH₄]/{[CH₄]+[SiH₄]}) used during the depositing makes it possible to adjust the final carbon content in the film and thus to adjust the properties of the material, in particular the refractive index and the bandgap (Solomon et al. [19], Solomon et al., Phys. Rev. B., 1988, 38, 13263-13270 [34]). The influence of the depositing of films of a-Si₁₋ₓCₓ:H on the LSPR properties was studied. Indeed, similar investigations on these same nanostructures coated with a 20 nm layer of SiOx (n=1.48−1×10⁻⁵i) showed a shift in the maximum absorption toward the short wavelengths of 7.4 nm with an increase in absorption of 0.029 in water (Szunerits et al., [35]). To conduct this study, a-Si₁₋ₓCₓ:H films 20 nm thick having carbon contents ranging from 3% to 37% are deposited, and the effect of the deposit on the UV-visible transmission spectrum of the interface is then investigated (FIG. 5). It is noted that the depositing of the a-Si₁₋ₓCₓ:H films shifts the LSPR bands toward the higher wavelengths while at the same time increasing their full width at half maximum. FIG. 5 shows that a low carbon content results in a smaller shift. In addition, an increase in the carbon content in the a-Si₁₋ₓCₓ:H film above 20% decreases the absorption and increases the full width at half maximum. These behaviors are linked to a change in the real and imaginary parts of the refractive indices of the a-Si₁₋ₓCₓ:H alloys formed. Said indices vary between n=4.2−0.07i for a-Si:H and n=1.81−1.07×10⁻³i for a-Si_{0.63}C_{0.37}:H, respectively. The a-Si₁₋ₓCₓ:H film with a carbon content of 20% has favorable spectral characteristics in terms of sensitivity and intensity of absorption with a maximum absorption at λmax=614 nm, a peak absorption of 0.29 and a full width at half maximum of 150 nm.

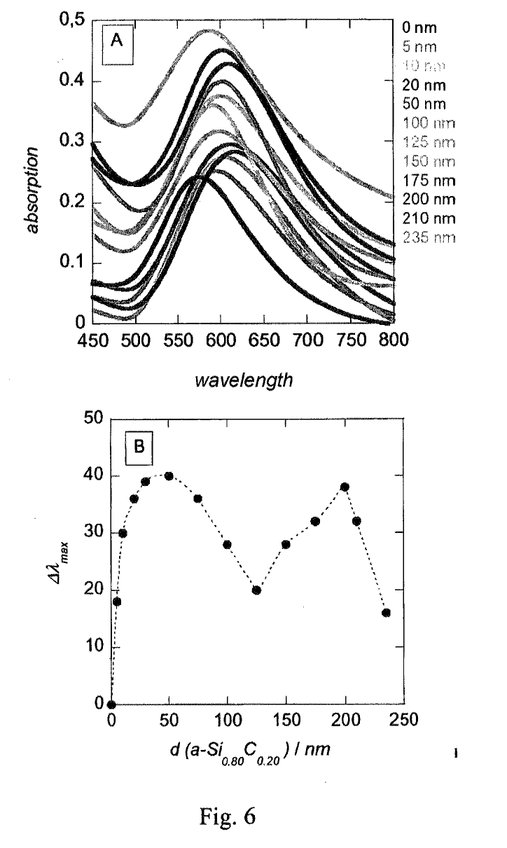

The influence of the thickness of a-Si_{0.80}C_{0.20}:H on the shift in the maximum LSPR absorption is now examined. Indeed, an oscillation behavior has recently been reported for gold nanoparticles coated with a thin film of SiOₓ in water (Szunerits et al., [35]). FIG. 6A shows the changes in the UV-visible transmission spectrum when the gold nanoparticles are coated with a film of a-Si_{0.80}C_{0.20}:H of increasing thickness. The spectrum representing the shift in λₘₐₓ as a function of the thickness of the a-Si_{0.80}C_{0.20}:H film shows an oscillation behavior with a period of 125 nm and an amplitude Δλₘₐₓ of 40 nm (FIG. 6B). The depositing of a 5 nm film of a-Si_{0.80}C_{0.20}:H causes a shift in λmax of 20 nm toward the long wavelengths compared with uncoated gold nanostructures. The sensitivity was determined by dipping these various structures in solvents of different refractive indices. A change in Δλₘₐₓ of 9 nm per unit of refractive index is observed for a 20 nm film of a-Si_{0.80}C_{0.20}:H, while a change of 50 nm per unit of refractive index is observed for a layer 5 nm thick. This sensitivity is indeed in harmony with studies already published (Haynes and Van Duyne, J. Phys. Chem., 2001, 105, 5599-5611 [36]). The use of interfaces coated with films of 150-200 nm is possible for long-distance detection studies, with a shift in Δλₘₐₓ of 50 nm per unit of refractive index.

The chemical stability of the LSPR interfaces coated with a 5 nm film of a-Si_{0.80}C_{0.20}:H was tested by monitoring the LSPR signal of interfaces dipped in water, ethanol and a phosphate buffer at ambient temperature. No change in the LSPR signal was observed during these successive dipping operations, each of 2 h at ambient temperature. It is thus shown that these hybrid interfaces can withstand the functionalization steps and are stable during the kinetic measurements.

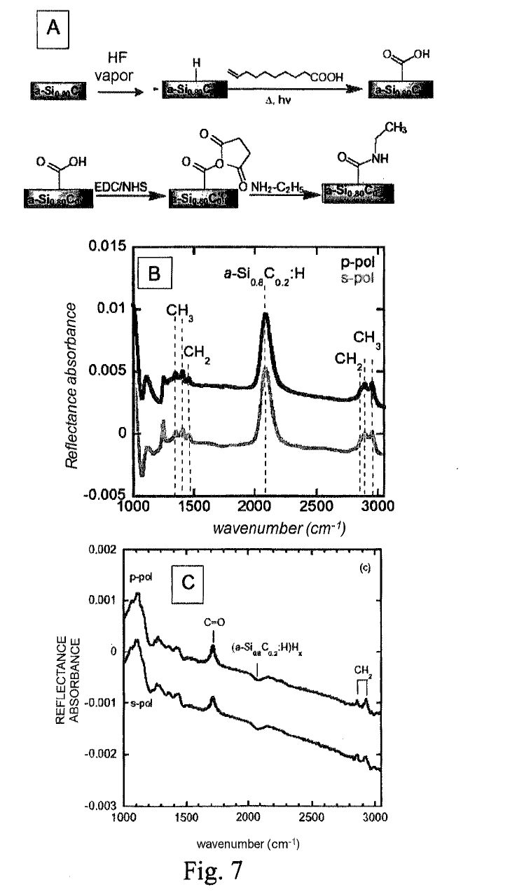

The LSPR interfaces are subsequently functionalized in order to allow the immobilization of biological molecules. The surfaces of the a-Si_{0.80}C_{0.20}:H films are first of all hydrogenated. The hydrogenated ending was obtained by exposing the interface to 50% HF vapors for seconds. Grafting of undecylenic acid is then performed by hydrosilylation under photochemical irradiation at 312 nm for 3 hours, followed by rinsing with acetic acid at 75° C. for 30 minutes (Faucheux et al., Langmuir 2006, 153-162 [31]). As shown in figure 7A, this allows grafting of carboxydecyl groups via Si—C bonds (Voicu et al., Langmuir 2004, 20, 11713-11720 [37]). FIG. 7B shows the ATR-FTIR (Attenuated Total Reflection Fourier Transform Infrared Absorption) spectrum of an a-Si_{0.80}C_{0.20}:H surface deposited on a silicon ATR prism and then hydrogenated, with reference to the spectrum of the bare crystalline silicon prism. The strong peak at 2100 cm⁻¹ confirms the presence of a large amount of silicon-hydrogen bonds in the material. The bands detected at 2890 cm⁻¹ and 2953 cm⁻¹ indicate that the carbon in the film is predominantly in CH₃ form (Solomon et al. [19]).

The vibrational bands C═O at 1711 cm⁻¹, and CH₂ at 2855 cm⁻¹ and 2930 cm⁻¹ in FIG. 7C indicate the grafting of carboxydecyl groups onto the thin a-Si_{0.80}C_{0.20}:H layer. The integration of the area of the peaks of the C═O band makes it possible to determine the molecular density of the carboxydecyl groups bonded: N=7.8±0.2×10¹³ mol cm⁻². This value, which is lower than that of the crystalline silicon (N=2.5±0.2×10¹⁴ mol cm⁻²) (Moraillon et al., Phys. Chem. C 2008, 112, 7158-7167 [38]), is probably due to roughness of the surface and to the presence of methyl groups at the surface.

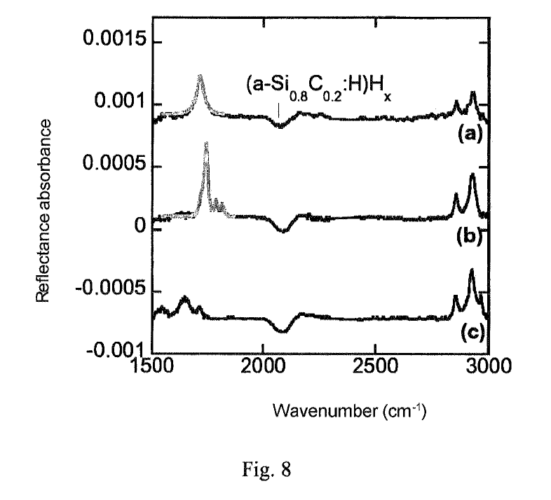

The acid function is subsequently converted into an ester group in a solution of EDC/NHS (N-ethyl-N′-[3-dimethylaminopropyl]carbodiimide/N-hydroxysuccinimide) at 5 mM/5 mM for 1 h30 at ambient temperature. FIG. 8 shows the FTIR spectrum of the interface before and after the conversion of the acid to ester. The complete disappearance of the peak characteristic of the acid at 1711 cm⁻¹ and the appearance of new peaks at 1744, 1788 and 1816 cm⁻¹, due to the elongation modes of the three carbonyl functions of the succinimidyl ester, are coherent with the formation of activated esters (Voicu et al. [37]). The amount of ester groups formed is estimated at N=7.2±0.2×10¹³ mol cm⁻² (Moraillon et al. [38]). This corresponds to an activation efficiency of 92%.

The reactivity of the NHS groups on the surface for the chemical conversions envisioned is demonstrated via an aminolysis reaction with ethanolamine. The ATR-FTIR spectrum of the ester-activated surface after reaction with ethanolamine is shown in FIG. 8c. The appearance of peaks at 1651 and 1551 cm⁻¹, attributed to the carbonyl function and to the CNH vibration of the amide, is observed. The amount of amide groups formed is N=7.2±0.2×10¹³ mol cm⁻². The remaining carboxyl peaks at 1711 cm⁻¹ reveal the nonactivated acids (Moraillon et al. [38]).

In summary, the production of hybrid plasmon interfaces based on the depositing of hydrogenated amorphous silicon-carbon alloys onto gold nanostructures provides the advantage of being able to easily, and in a well controlled manner, graft carboxyl functions directly onto the interface via Si—C bonds. Such functions can readily react with the reactive amine endings present in many biological compounds.

Moreover, these hybrid interfaces make it possible to jointly obtain good sensitivity for the detection of the LSPR and enhancement of the fluorescence of grafted probes. This capacity is demonstrated here by grafting probe oligonucleotides to the interface, and by monitoring, on the same support, by fluorescence, in situ and in real time, a cycle of hybridization and dehybridization of probes with their complementary targets, and monitoring the hybridization kinetics by LSPR.

In a manner analogous to example 1, studies of fluorescence enhancement, this time of plasmon origin, are carried out.

The immobilization protocol is the following. Two oligonucleotide probes are used: a 25-mer probe [5′ Cy5-AGG-CGT-CGA-TTT-TAA-GAT-GGG-CGT-T-(CH₂)₆—NH₂ 3′] (SEQ ID NO. 4) called ON4 and an unlabeled 25-mer probe [5′—NH₂—(CH₂)₆-AAC-GCC-CAT-CTT-AAA-ATC-GAC-GCC-T-3′] (SEQ ID NO. 5) called ON5. The two probes, diluted to 10⁻⁵M in 150 mM of a phosphate buffer (PBS) containing 0.01% of SDS (sodium dodecyl sulfate) at pH 8.5, are deposited on the activated surface. The target used is a 25-mer [5′ Cy5-AGG-CGT-CGA-TTT-TAA-GAT-GGG-CGT-T 3′] (SEQ ID. NO. 6) called ON6.

The immobilization is carried out by spotting onto the activated surface for the fluorescence measurements according to the procedure described in example 1. For the LSPR measurements, the oligonucleotides are immobilized on the entire slide by leaving the solution to react for 14 h in a hybridization chamber.

### Measurement of Fluorescence

The sensitivity obtained is first evaluated by measuring the fluorescence with a scanner (Axon Instruments Personal 4100A) after immobilization of the Cy5-labeled ON4 probe and hybridization of the ON5 probe with the Cy5-labeled oligonucleotide complementary thereto. Several hybridization/dehybridization cycles are carried out and monitored in situ by fluorescence (Marcy et al., 2008, BioTechniques 44, 913-920 [32]), by means of a Hyblive (trademark) realtime hybridization station (Genewave). The dehybridization is carried out in situ at 50° C. in the Hyblive chamber in a mixture of formamide and 2.5×SSC (saline sodium citrate buffer) (50:50 by vol.). A fluorescence image (integration time 1 second) is recorded every 30 seconds.

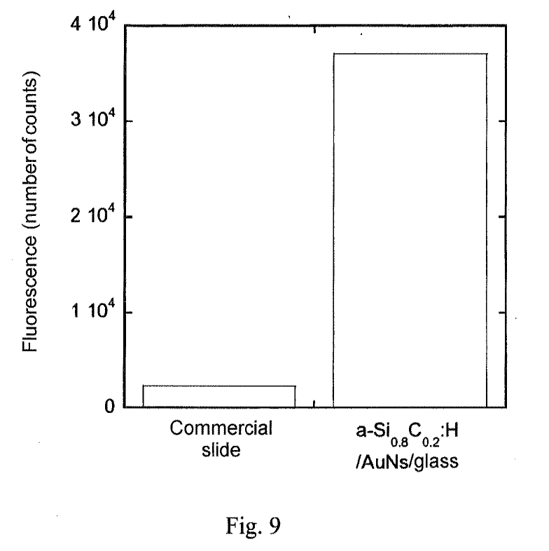

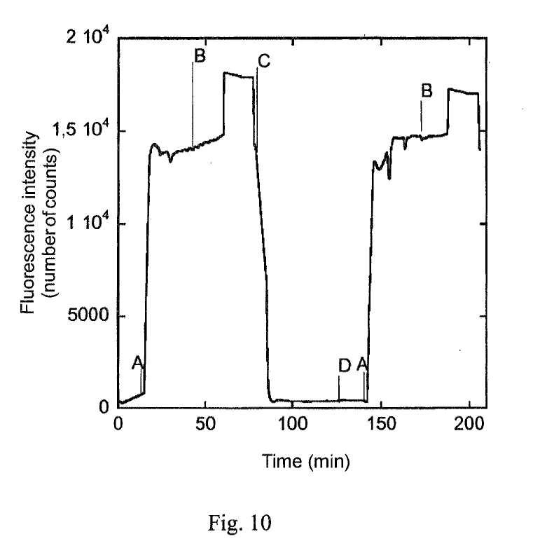

FIG. 9 shows in histrogram form the intensity of the fluorescence recorded in the case of a-Si_{0.80}C_{0.20}:H of nm deposited on the nanostructures, in comparison with a commercial slide. In order to be able to compare them, the same immobilization and hybridization conditions were used on our slides and on the commercial glass slides. FIG. 9 shows that the total improvement is by about a factor of 17 relative to the commercial slide. This sensitivity makes it possible to monitor the hybridization in real time. FIG. 10 shows that this support makes it possible, just as in example 1, to record several successive hybridization-dehybridization cycles without any loss of sensitivity.

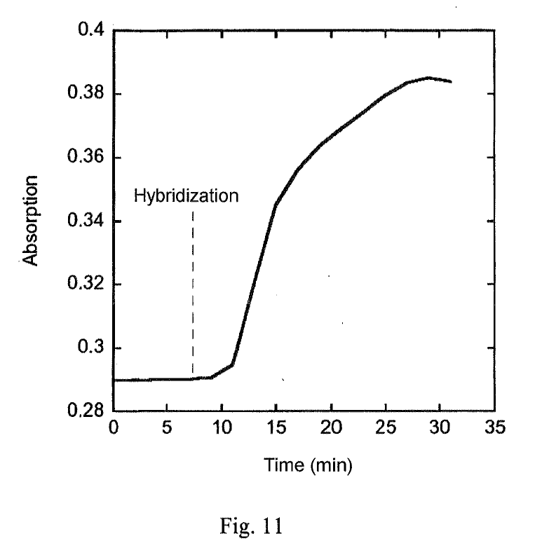

This same sensor is used in order to monitor, as a function of time, the change in the LSPR peak during the hybridization. The shift in the peak is quantified by observing the modification of absorption for a fixed wavelength which is well chosen, preferably in the maximum slope range, on the long-wavelength side of the LSPR peak. During the reaction, the characteristics of the peak, such as its intensity or the position of the maximum absorption, change, thus inducing the change in the absorption at the chosen wavelength. The surface comprising the immobilized ON4 oligonucleotide probes is placed in PBS buffer containing 0.01% of SDS (sodium dodecyl sulfate) at pH 8.5, in order to record a reference measurement. The buffer is then removed and the surface is exposed to a solution of ON5 at a concentration of 500 nM. FIG. 11 illustrates the hybridization kinetics thus obtained from the shift in the LSPR peak as a function of time.

By allowing this double detection by LSPR and by fluorescence, these novel types of reusable interfaces open up new perspectives for analysis, in particular in the context of kinetic measurements and quantitative characterizations.

### Example 3

### Surface Plasmon Resonance on Gold Films Coated with Thin Layers of Amorphous Silicon-Carbon Alloys

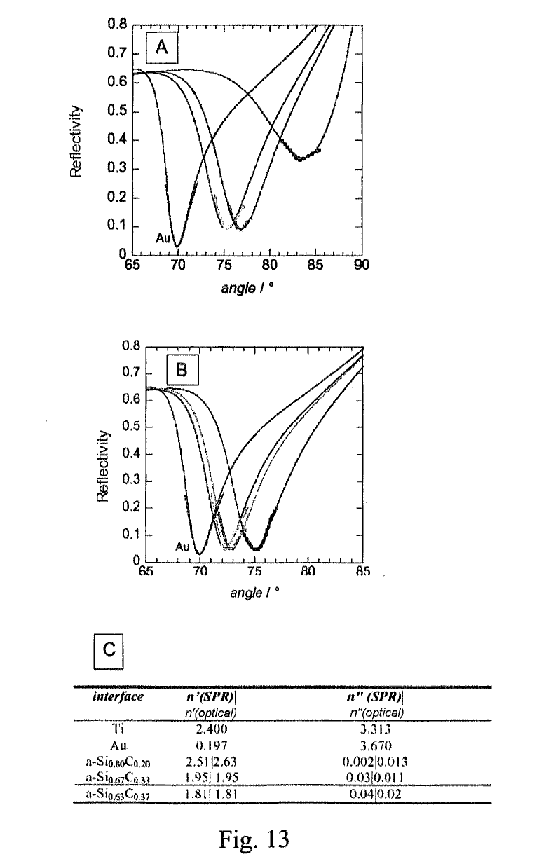

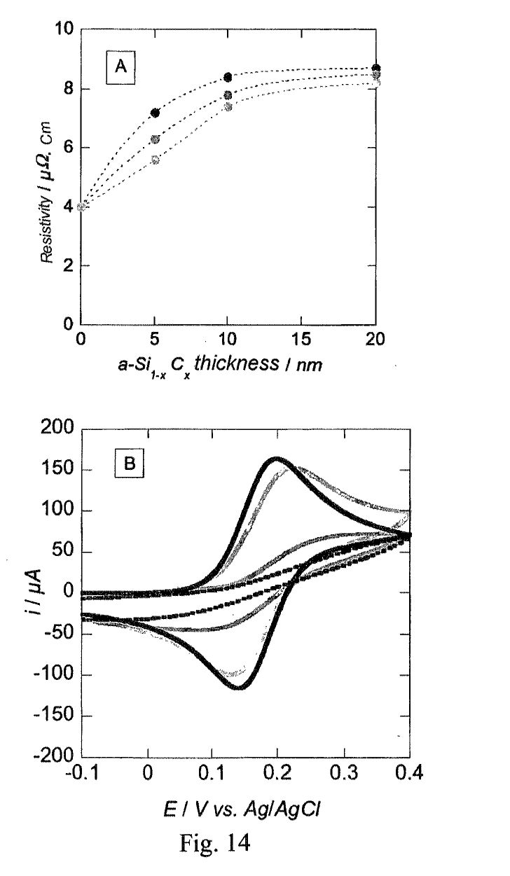

Films of carbonaceous amorphous silicon are deposited by “low-power” PECVD (Solomon et al., Physical Rev. B., 1988, 38, 13263 [34]). The following parameters are used: pressure=35 mTorr, temperature=250° C., power=0.06 W cm⁻², gas flow rate=20 cm³ min⁻¹. The final carbon (C) content in the material can be adjusted by varying the proportion of methane in the gas mixture ([CH₄]/{[CH₄]+[SiH₄]}). For depositing a thin film with the following stoichiometry: a-Si_{0.63}C_{0.37}:H, 94 at. % of [CH₄] are used, whereas for an a-Si_{0.80}C_{0.2.0}:H film, 51 at.% are necessary. The influence of the carbon content of an a-Si₁₋ₓCₓ:H film on the SPR signal is determined for a content of between 20 and 37%. The influence of the thickness of the film is also studied between 0 and 10 nm. FIG. 13 shows the experimental SPR curves superimposed on the Fresnel theoretical curves. For structures having equal film thicknesses, the differences in the SPR curves are due to the modification of the refractive index. A greater carbon content induces a decrease in the refractive index at 633 nm from n=2.63−5×10⁻⁴i (a-Si_{0.80}C_{0.20}:H) to n=1.815−1.07×10⁻³i (a-Si_{0.63}C_{0.37}:H), respectively. Increasing the carbon content decreases the refractive index, but also results in an increase in its imaginary part. With a coating having a carbon content of 37%, a decrease in the photon-plasmon coupling efficiency and a broadening of the SPR curves are noted. The best interface in terms of SPR signal is obtained using a 50 nm layer of gold deposited on a 5 nm layer of titanium (5 nm Ti/50 nm Au) and coated with a 5 nm film of a-Si_{0.63}C_{0.37}:H. The chemical stability of the interface is studied by dipping for 6 hours in 0.1M H₂SO₄ and 0.1M NaOH. No change in the SPR signal is recorded after these treatments, which indicates that the a-Si_{0.63}C_{0.37}:H film 5 nm thick effectively stabilizes the metal surface, and will withstand subsequent chemical functionalization steps. Electrical and electrochemical (cyclic voltammetry) measurements were carried out on various interfaces. When the conductivity is measured in the plane, a multilayer structure such as Ti/Au/a-Si₁₋ₓCₓ:H can be described in terms of three resistances in parallel, the resistance R of the interface being equal to: 1/R=1/R_{Ti}+1/R_{Au}+1/Ra—Si₁₋ₓCₓ (R_{Ti} being the resistance of the titanium layer, R_{Au} that of the gold layer and Ra—Si₁₋ₓCₓ that of the alloy layer). FIG. 14A shows the change in the resistivity of the hybrid interfaces as a function of thickness for three different carbon contents. The resistivity decreases with the carbon content and increases with the thickness of the layer, reaching a limit when the layer is approximately 20 nm thick. This suggests that the overall resistivity is determined by the resistivity of the gold layer rather than by the resistivity of the coating. This is confirmed by cyclic voltammetry experiments using Fe(CN)₆⁴⁻ as a redox probe (FIG. 14B). The gold coated with 5 nm of a-Si_{0.63}C_{0.37}:H shows charge transfer kinetics similar to those of the gold alone, whereas, when it is coated with 5 nm of a-Si_{0.67}C₀₋₃₃:H or with a-Si_{0.80}C_{0.20}:H, the charge transfer kinetics of the electrode are partially blocked.

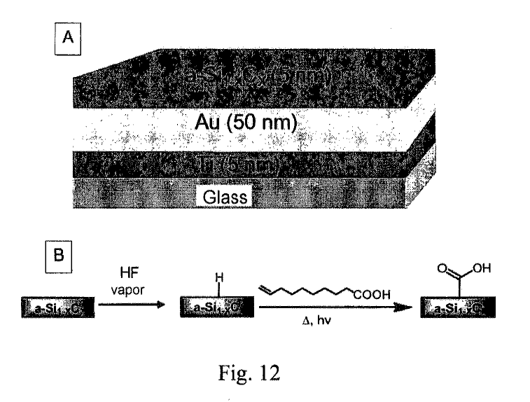

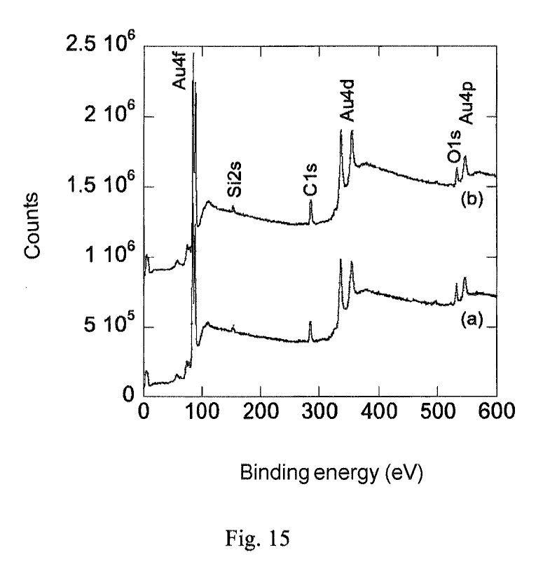

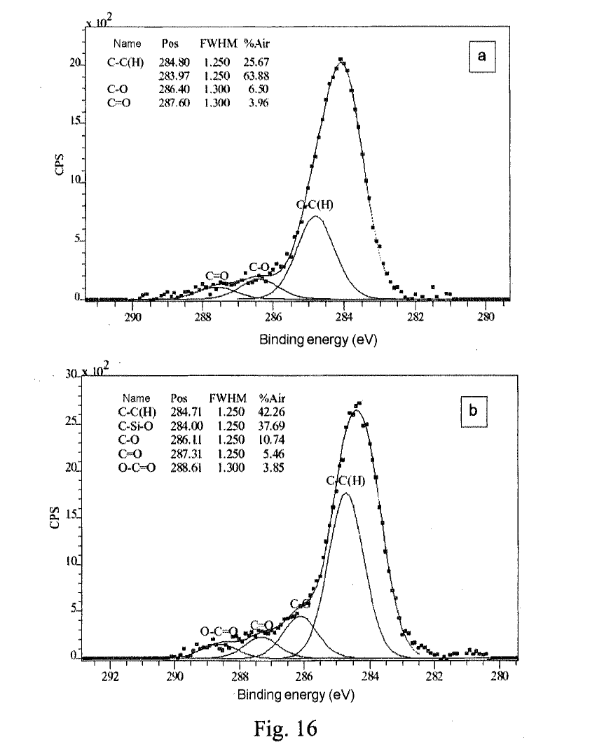

The a-Si_{0.63}C_{0.37}:H film is partially oxidized and a thin SiO₂ passivation layer is formed on its surface after exposure to the ambient environment. The thin oxidized layer can be removed by simple exposure of the interface for 15 seconds to HF vapors in order to obtain a surface which ends with Si—Hₓ bonds. The hydrogenated surface of the a-Si_{0.63}C_{0.37}:H film is then dipped in undecylenic acid (CH₂═CH—(CH₂)₈—COOH) and subjected to photochemical irradiation at 312 nm for 3 h. This treatment results in the formation of an organic monolayer covalently bonded to the surface via Si—C bonds (FIG. 12B). X-ray photoelectron spectroscopy (XPS) and contact angle measurements are used to analyze the chemical composition and the nature of the chemical bonding on the surface of the a-Si_{0.63}C_{0.37}:H before and after the modification with undecylenic acid. A change in contact angle from 95±1° for a-Si_{0.63}C_{0.37}:H to 75±1° for a-Si_{0.62}C_{0.37}:H modified with undecylenic acid indicates that the reaction has taken place. The XPS spectrum of freshly deposited a-Si_{0.63}C_{0.37}:H is shown in FIG. 15a. Because of the high sensitivity factor of gold in XPS and the small thickness of the a-Si_{0.62}C_{0.37}:H film, the spectrum is dominated by the signals from the gold: peaks at 84 and 88 eV (energy levels Au 4f), 335 and 353 eV (Au 4d), 547 eV (Au 4p_{3/2}) and 643 eV (Au 4p_{1/2}). In addition to the gold peaks, signals at 285 eV for C 1s, 532 eV for O 1s and 153 eV for Si 2s are also observed. The Si 2p signal at 99 eV is affected by the strong plasmon satellite associated with the Au 4f peaks. The C/Si (carbon/silicon) and C/O (carbon/oxygen) ratios are 4 and 2.6, respectively. The high-resolution spectrum of the C 1s band is shown in FIG. 16a. This band can be broken down into four components. The main peak is centered at 283.9 eV and is characteristic of C—Si bonds, while the signals at 284.8, 286.4 and 287.6 eV correspond to the (CH₂)ₙ, C—O and C═O structures. Since the process for forming the a-Si_{0.63}C_{0.37}:H film uses high concentrations of methane, it may be assumed that the material obtained contains not only Si—CH₃ groups, but also (CH₂)ₙ groups (Suzuki et al., Jpn. J. App. Sci., 1990, 29, L663 [39]). The XPS spectrum of a-Si_{0.63}C_{0.37}:H after grafting of carboxydecyl groups shows the same characteristic bands as the unmodified surface (FIG. 15b). However, the C/Si and C/O ratios increase to 10.0 and 4.5, respectively. Furthermore, the high-resolution C1s spectrum, shown in FIG. 16b, can be broken down into five different components. The main peak centered at 284.7 eV is characteristic of CH₂ groups of alkyl chains and (CH₂)ₙ structures, whereas the other peaks at 284.0, 286.1 and 287.3 eV correspond to C-Si, C—O and C═O functions, as was seen for the unmodified interfaces. An additional band at 288.6 eV, characteristic of O—C═O bonds, is also present, attesting to the functionalization of the surface with undecylenic acid.

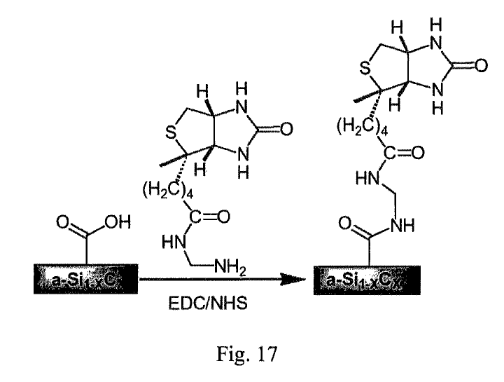

The carboxylic acid functional group is particularly useful for its chemical reactivity and its wetting properties (Moraillon et al., [38]; Blankespoor et al., Langmuir, 2005, 21, 3362 [40]). The SPR interfaces functionalized with a carboxyl group are advantageously used for coupling with ligands that end with an amine, as is shown in FIG. 17. Avidin-biotin systems have often been used as affinity assembly systems for the production of biosensors (Wayment and Harris, J. M. Anal. Chem., 2009, 81, 336 [41]). Such systems can be easily used here by coupling a biotin group located in the terminal position on an aminoalkyl group (biotin-NH₂). Starting from a surface comprising COOH endings, the chemical activation of the acid functions to give succinimidyl functions is first of all carried out as described in example 2 using N-hydroxysuccinimide (NHS) in the presence of N-ethyl-N′-(3-dimethylamino-propyl)carbodiimide. The resulting esters then react with the biotin-NH₂ by aminolysis under physiological conditions. The biotin group is thus grafted to the molecular layer by formation of an amide bond. The biotin-modified interface exhibits a contact angle of 70°.

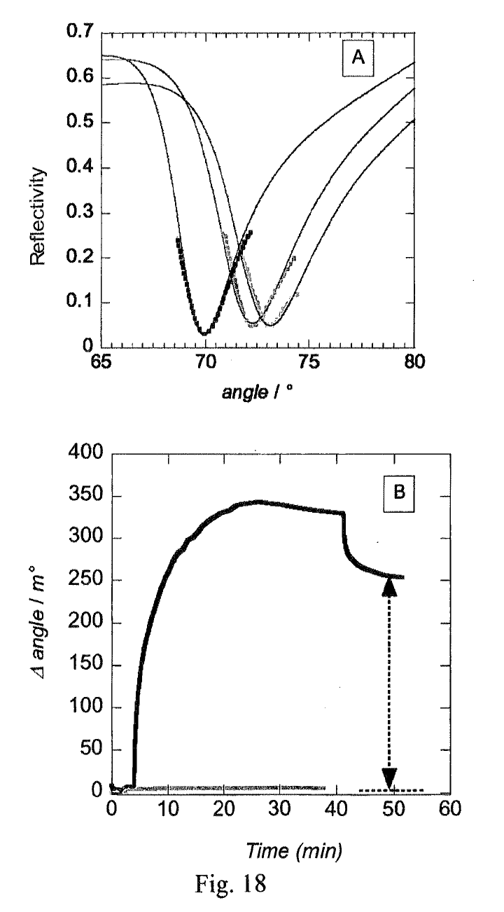

According to the reflectivity curves (FIG. 18A), the bonding of the NH₂ modified biotin to the surface results in a change of angle of the SPR, which can be modeled via an equivalent variation in thickness of 3.1 nm, which is coherent with the molecular size of unmodified biotin (0.52 nm×1.00 nm×2.10 nm) (Lin et al., Langmuir 2000, 18, 788 [29]). The biotin-streptavidin molecular recognition (5.60 nm×5.00 nm×0.40 nm) (Karajanagi et al., Langmuir 2004, 20, 11594, [42]) is monitored by SPR, and the coupling reaction kinetics are shown in FIG. 18B. As expected, a large increase (change of angle of 0.25°) is observed for the biotin-modified interfaces, whereas only a small increase was observed for that which was not modified. The change of angle of 0.25° corresponds to the thickness of the streptavidin layer of approximately 6.3 nm (Knoll et al., Colloid. Surf. A: Physicochem. Eng. Aspects, 2000. 161, 115-137 [43]).

In summary, an SPR substrate architecture based on the coating of a gold substrate with amorphous silicon-carbon alloys 5 nm thick can be produced by depositing thin films of a-Si₁₋ₓCₓ:H followed by the grafting of stable organic monolayers via Si—C bonds as shown in FIG. 12. For the purpose of biological analysis, a biotin group can be grafted onto this molecular layer by the formation of an amide bond. The advantage of the novel interfaces is illustrated here in the analysis of the specific avidin-biotin interaction. This novel architecture opens up numerous possibilities for the fabrication of SPR interfaces for the analysis of molecular interactions.

### LIST OF REFERENCES

[1] U.S. Pat. No. 6,194,223
[2] WO2005040770
[3] US2006066249
[4] US2009045351
[5] U.S. Pat. No. 6,194,223
[6] U.S. Pat. No. 5,449,918
[7] US2007273884
[8] US2002085204
[9] EP 1422315
[10] WO02052260
[11] WO2007036544
[12] U.S. Pat. No. 6,726,881
[13] A. J. Haes, R. P. Van Duyne, J. Am. Chem. Soc. 2002, 124, 10596-10604
[14] M. E. Stewart, C. R. Anderton, L. B. Thompson, J. Maria, S. K. Gray, J. A. Rogers, R. G. Nuzzo, Chem. Rev. 2008, 108, 494-521
[15] N. Blow, Nature Methods 2009, 6, 389-393)
[16] US2004096893
[17] C. Dahmen, A. Janotta, D. Dimova-Malinovska, S. Marx, B. Jeschke, B. Nies, H. Kessler and M. Stutzmann, (Thin Solid Films 2003, 427, 201-207)
[18] A. Lehner, G. Steinhoff, M. S. Brandt, M. Eickhoff, M. Stutzmann, J. Appl. Phys. 2003, 94, 2289-2294
[19] I. Solomon, M. P. Schmidt, H. Tran-Quoc, Phys. Rev. B., 1988, 38, 9895-9901
[20] L. R. Tessler, I. Solomon, Phys. Rev. B 1995, 52, 10962-10971
[21] J. I. Pankove, Hydrogenated Amorphous Silicon, Semiconductors and Semimetals Vol. 21, part A: Preparation and Structure, Academic, Orlando, 1984.
[22] R. A. Street, Hydrogenated Amorphous Silicon, 1991, Cambridge University Press, Cambridge
[23] Edith Chow, Elicia L. S. Wong, Till Böcking, Quynh T. Nguyen, D. Brynn Hibbert and J. Justin Gooding, Sensors and Actuators B 111-112 (2005) 540-548
[24] Y. Chen et al., Nano Letters, vol. 7, No. 3, 690-696, 2007
[25] A. Bek et al., Nano Letters, vol. 8, No. 2, 485-490, 2008
[26] Aslan et al., Current Opinion in Chemical Biology, 9:538-544, 2005 ([23]).
[27] P. Neuzil and J. Reboud (Anal. Chem. 2008, 80, 6100-6103
[28] WO2008132325
[29] Lin et al. Langmuir 2000, 18, 788
[30] Ciampi et al., 2007 langmuir 23, 9320-9329
[31] Faucheux et al., 2006 Langmuir 22, 153-162
[32] Marcy et al., 2008, BioTechniques 44, 913-920
[33] Born and Wolf, 1970. Principles of Optics, fourth ed. Pitman Press, Bath
[34] Solomon et al., Phys. Rev. B., 1988, 38, 13263-13270
[35] Szunerits et al., J. Phys. Chem. C 2008, 112, 8239-8243
[36] Haynes and Van Duyne, J. Phys. Chem., 2001, 105, 5599-5611
[37] Voicu et al., Langmuir 2004, 20, 11713-11720
[38] Moraillon et al., Phys. Chem. C 2008, 112, 7158-7167
[39] Suzuki et al., Jpn. J. App. Sci., 1990, 29, L663
[40] Blankespoor et al., Langmuir, 2005, 21, 3362
[41] Wayment and Harris, J. M. Anal. Chem., 2009, 81, 336
[42] Karajanagi et al., Langmuir 2004, 20, 11594
[43] Knoll et al., Colloid. Surf. A: Physicochem. Eng. Aspects, 2000. 161, 115-137
[44] de Smet et al., J. Am. Chem. Soc. 2003, 125, 13916-13917
[45] Suo et al., Langmuir 2008, 24, 4161-4167
[46] FR2585730
[47] FR2529582
[48] J. M. Buriak, Chem. Rev. 102, 1271 (2002)
[49] R. Boukherroub, Curr. Opin. Solid State Mater. Sci. 9, 66 (2005)
[50] R. Boukherroub and S. Szunerits, Electrochemistry at the Nanoscale, Nanostructure Science and technology Series. Eds. P. Schmuki and S. Virtanen, Springer-Verlag New York, LLC, 2008, pp: 183-248
[51] C. Henry de Villeneuve, J. Pinson, M. C. Bernard, P. Allongue, J. Phys. Chem. B 101, 2415 (1997)
[52] S. Fellah, A. Teyssot, F. Ozanam, J.-N. Chazalviel, J. Vigneron, A. Etcheberry, Langmuir 18, 5851, (2002)
[53] A. Teyssot, A. Fidélis, S. Fellah, F. Ozanam, J.-N. Chazalviel, Electrochim. Acta 47, 2565 (2002). 53
[54] C. Gurtner, A. W. Wun, M. Sailor, Angew. Chem. Int. Ed. 38, 1966 (1999)
[55] E. G. Robins, M. P. Stewart, J. M. Buriak, Chem. Commun. 2479 (1999)
[56] K. L. Prime et al., J. Am. Chem. Soc., 1993, 115, 10714-10721
[57] T. Böcking et al., Langmuir, 2005, 21, 10522-10529
[58] J. P. Conde, A. C. Pimentel, A. T. Pereira, A. Gouvêa, D. M. F. Prazeres, V. Chu, J. Non-Cryst. Solids 2008, 354, 2594-2597.

1. A method of detecting substances or reactions of substances in a sample, comprising: (i) providing a layer (CS) based on hydrogenated or unhydrogenated amorphous silicon with attached probes; (ii) bringing the layer (CS) in contact with the sample that may contain the substances that bind specifically to or reacts specifically with the probes, under appropriate conditions for the substances to bind to or react with the probes; (iii) optionally removing non-specifically bound or non-specifically reactive substances; and (iv) detecting the presence or amount of the specifically bound or reactive substances in the sample by surface plasmon resonance (SPR) and/or fluorescence.

2. The method of claim 1, in which said layer (CS) has a thickness less than 20 nm.

3. The method of claim 1, which is an analysis in which said layer (CS) has a thickness chosen from the range of values which correspond to the first maximum reflectivity on a graph representing the reflectivity of the analysis structure as a function of the thickness of said layer (CS) for the various wavelengths of the radiations used for the excitation and detection during the analysis.

4. The method of claim 1, in which said layer (CS) has an atomic fraction [C]/([C+Si]) between 0 and 0.4.

5. The method of claim 1, in which said layer (CS) is deposited on a substrate (S).

6. The method of claim 1, in which said layer (CS) is deposited on a metal layer (M).

7. The method of claim 6, in which said metal layer is continuous or discontinuous.

8. The method of claim 6, in which said metal layer is discontinuous and comprises aggregates which have at least two submicron dimensions.

9. The method of claim 6, in which said metal layer comprises a metal selected from the group consisting of copper, silver, gold, rhodium, lithium, sodium, potassium, rubidium, cesium, magnesium, calcium, strontium, barium, zinc, cadmium, aluminum, gallium, indium, lead and a mixture of at least two of these metals.

10. The method of claim 1, in which said layer (CS) comprises at its surface a molecular layer (CM).

11. The method of claim 10, in which said molecular layer comprises a means of attachment of a ligand, of an organic molecule, of a biomolecule, of a microorganism or of a part of a microorganism to its surface.

12. The method of claim 1, in which said probes are selected from the group consisting of ligands, organic molecules, biomolecules, microorganisms and parts of microorganisms and are present at the surface of said layer (CS).

13. The method of claim 1, in which the surface plasmon resonance is located (PR).

14. The method of claim 1, in which the method is selected from the group consisting of a method of monitoring the progression of a biochemical synthesis, a method of detecting an interaction between ligands, small organic molecules or biomolecules, a method of detecting an interaction between a biomolecule and a microorganism or a portion of a microorganism, and a method of molecular screening.

15. The method of claim 1, in which said method comprises an analysis by fluorescence and by localized or nonlocalized surface plasmon resonance (SPR).

16. The method of claim 15, in which said analysis is carried out in liquid medium.
